(19) United States
(12) Patent Application Publication
(10) Pub. No.: US 2002/0163735 A1
(43) Pub. Date: Nov. 7, 2002

(54) Radially homogeneous high energy density UV sample ablating laser radiation in "pure" solid to gas sample preparation , for analysis by ICP-MS and ICP-OES

(76) Inventors: Gunther Detlef, Zurich (CH); Ingo Horn, Zurich (CH); Marcel Guillong, Zurich (CH)

Correspondence Address: JAMES D. WELCH, 10328 PINEHURST AVE., OMAHA, NE, 68124, US

(21) Appl. No.: 09/758,594

(22) Filed: Jan. 10, 2001

Related U.S. Application Data
(60) Provisional application No. 60/175,577, filed on Jan. 11, 2000.
(60) Provisional application No. 60/175,888, filed on Jan. 13, 2000.

(51) Int. Cl. G02B 27/30; G02B 27/14; G02B 27/12

(52) U.S. Cl. 359/641; 359/636; 359/637; 359/639

(57) ABSTRACT

Disclosed are systems for, and methods of forming and applying 40 micron or greater diameter, substantially radially homogeneous, relatively high, (eg. 30-60 or greater J/cm 2), energy density, preferably 200-380 nm UV wavelength, (typically Nd-YAG Iraser produced 213 nm or 266 nm wavelength), electromagnetic radiation laser pulse(s), or equivalent in a continuous wave, to uniformly substantially purely optically ablate material from sample systems; coupled with analysis thereof in (ICP-OES), (ICP-MS), (MIP-OES), (MIP-MS) or other plasma based analysis systems, with relative freedom from calibration errors arising from element fractionation. Further disclosed is methodology for uniformly ablating material from sample systems such as gem stones for high sensitivity, high acuracy analysis, the damaging effects of which are, or can be rendered undetectable; and methodology criteria for determining, accepting and applying combinations of electromagnetic radiation defining parameters for use in sample system ablation.

This Application is a CIP of Provisional Applications:

Serial No. 60/175,577 filed Jan. 11, 2000, and

Serial No. 60/175,888 filed Jan. 13, 2000.

### TECHNICAL FIELD

The present invention relates to the application of lasers in analytical chemistry, and more particularly to:

systems for, and methods of forming and applying relatively high energy density, (eg. 30-60 J/cm² or more, over 40-700 micron focused spot diameter), substantially radially homogeneous, (eg. 85% or higher uniformity), energy density profile 200-380 nm UV wavelength, (eg. Nd-YAG Laser produced 213 nm or 266 nm), electromagnetic radiation to uniformly ablate material from spots in solid sample systems, substantially by an optically induce direct solid-to-gas laser ablation mechanism, said ablated material being delivered in amounts and at rates conducive to analysis at high sensitivity in plasma based analysis systems, (eg. inductively coupled plasma (TCP-OES) optical emission, inductively coupled plasma mass spectrometer (ICP-MS), and microwave induced plasma (MIP) etc. systems); and

systems for, and methods of forming and applying substantially, radially homogeneous, (eg. 85% or higher), energy profile laser produced electromagnetic radiation to uniformly ablate material from spots in solid sample systems such as gem stones, substantially by an optically induced direct solid-to-gas laser ablation mechanism in an manner which prevents detectable damage, (eg. no deeper than approximately 2 microns over a 50-700 micron diameter region), thereto, or if damage does occur, it being of a minimal nature that can be rendered undetectable by jeweler's secondary polishing techniques; said ablated material being delivered in amounts and at rates conducive to analysis at high sensitivity in plasma based analysis systems such as inductively coupled plasma (ICP-OES) optical emission, inductively coupled plasma mass spectrometer (ICP-MS), and microwave induced plasma (MIP) etc. systems; and

methodology for determining optimum combinations of electromagnetic radiation parameters such as wavelength, degree of homogenization, fluence (energy density), pulse duration, pulse repetition rate, total number of pulses applied to a location on a sample system, and beam spot diameter of electromagnetic radiation at a location at which it impinges on a sample system, for use in ablating specified sample systems as monitored by, for instance, ratios of ablated high to low boiling point elements and/or compounds over time, ablated region aspect ratio of diameter to depth, substantially uniform ablation over the diameter of an ablated region, and degree of beam homogenization, as evidenced by radial energy distribution uniformity.

### BACKGROUND

The use of lasers to ablate material from solid systems, (eg. inductively coupled plasma (ICP-OES) optical emission and inductively coupled plasma mass spectrometer (ICP-MS), and microwave induced plasma (MIP) optical emmission and mass spectrometer etc.), to analyze said ablated material.

The range of solid materials which can be analyzed by laser ablation techniques include those which originate from sources such as geological, mining, metallurgical, manufacturing, food science, biological, medical and the chemical industry. It is noted that powder and liquid samples can be investigated by the laser ablation technique where said powder or liquid is first adsorbed or absorbed into a porous material to form an effective solid source or pressed into pellets.

Prior art laser ablation systems for use in rapid spot vaporization, (ie. ablation by laser), of solid sample material placed in an ablation cell are also well known. For instance, moderately focused, low power, (eg. 2-20 mJ, 266 or 213 nm Nd-YAG), laser beams which are caused to obliquely impinge upon the surface of a solid sample system, have been used to introduce resultant vapors and fine particle aerosols into a continuous flow of carrier gas, (eg. typically Argon (Ar) or Helium (He) or mixtures thereof), said continuous flow of carrier gas being used to cool and deliver said vapors and fine particulate aerosols to an (ICP-OES) or (ICP-MS) or (MIP) based analysis system.

Early laser ablation systems, such as those provided by Perkin Elmer Instruments, employed 1064 nm Nd-YAG laser heads which produced laser beams which were focused through microscope objective lenses obliquely onto the surface of a sample system. The 1064 nm laser, however, was found by users to cause undesirable localized, step-wise, kinetically dependent heating effects within a sample system being ablated. The reason for this is that the energy in the 1064 nm radiation arriving at a sample system surface is first absorbed by the sample system material and is then redistributed to variable depths and diameters at variable rates, (dependent on thermal conductivity of the sample system material), in the form of heat. Said heat causes elements and compounds present within the sample system volume affected thereby to be heated to or above their melting, and then boiling points. The problems inherent in this include:

1. initial sample absorbency to 1064 nm radiation is quite variable from one material to another, and is often too low in transparent sample materials such as glasses and optical materials;

2. thermal conductivities which control heat distribution vary from one sample system material to another;

b 3. melting and boiling points of different elements and compounds in the same sample system vary widely; and

4. melting and boiling points of elements and compounds vary with sample system material.

In view of the fact that optical absorbancies and thermal conductivities vary widely with sample system material, and that melting and boiling points vary widely amongst different elements and compounds in the same media, and that melting and boiling points of elements and compounds vary with sample system material, it has become clear that it is very difficult to accurately predict, quantify and calibrate for vaporization rate and yield when the 1064 nm laser is utilized at typically employed energy densities. That is, variable optical absorbancy and localized, kinetically dependent, step-wise heating processes which give rise to uncontrolled time and material dependent fractional distillation matrix effects predispose laser based ablation systems operating at 1064 nm at typically employed energy densities to severe accuracy and calibration problems.

While, to some extent, calibration using standard reference materials which contain known amounts of test elements enables a semi-quantitative degree of analysis, it is noted that known standard reference materials rarely match an unknown sample system long wavelength optical absorbancy and material composition exactly. In addition, standard reference materials, when available, are expensive, and in many cases, appropriate standard reference materials are simply not available.

Continuing, prior to the present invention, conventional understanding reported in known prior art was that the key to reducing localized uncontrolled stepwise heating effects and making laser ablation (ICP-OES) optical emission and (ICP-MS) or (MIP) based system elemental analysis of elements and compounds in solid samples more accuratively quantitative, was to use lasers which produced shorter wavelengths, and it is noted that in the attempt to make laser ablation (ICP-OES) optical emission and (ICP-MS) or (MIP) based system analysis of solid samples more quantitative in its calibration and in its final accuracy, 1064 nm Nd-YAG laser systems have been largely abandoned in favor of shorter wavelength systems which operate in regions of greater sample optical absorbancy and provide somewhat better direct solid-to-vapor ablation characteristics, with corresponding reduced localized stepwise media heating effects and reduced dependency on sample transparency. Commercially available Nd-YAG laser ablation systems, produced by CETAC Technologies, Merchantek, and (formerly) VG, operate at 2-6 mJ, and provide a wavelength of 266 nm, (with a few Merchantek systems operating at 213 nm).

It is noted that where sample absorbancy is sufficient and a direct solid-to-gas ablation transition mechanism dominates, the undesirable effects of sample system material thermal conductivity, and of melting points and boiling points of the said sample system material and of elements and compounds therein which are being tested for, are reduced. However, said commercially available Nd-YAG laser ablation systems which operate at 2-6 mJ, provide electromagnetic beams focused to provide energy densities of less than 30 J/cm² at typical spot diameters of 30 microns and greater at a wavelength of 266 nm, have been only partially successful in overcoming the shortcomings of the ablation systems which operate at longer wavelengths, as they provide only partial substitution of direct solid to gas ablation mechanism, due to inadequate energy density and residual spatial inhomogeniety of electromagnetic radiation. It is emphasized that ablation below 40 microns generally provides insufficient material for many high sensitivity sample analysis applications in (ICP-MS) and (ICP-OES) and (MIP) based systems. Larger area sample ablation (eg. 40-700 microns) spot size is clearly needed, while still maintaining high energy density, (eg. greater than 35 J/cm2 over said 40-700 micron diameter area).

Of more recent commercial introduction, (by Microlas Inc. of Gottingen, Germany), is an Excimer laser ablation system which operates at 193 nm. While said system provides many scientifically desirable features, (eg. high energy density homogenized beam), required to maximize domination by the solid-to-gas laser ablation mechanism, (even in spot sizes well above 40 microns in diameter and constant for all spot sizes), it is relatively bulky, (eg. the laser head alone is about five times the size and weight of a Nd-YAG laser system), system component alignment is difficult, and the Microlas 193 nm system is quite expensive, at more than $130,000 per Gaussian beam system and $230,000 for homogenized beam systems. It is noted that (ICP-OES) optical emission and (ICP-MS) spectrometers and (MIP) based systems to which the laser ablation system is a solid sampling accessory, are often relatively considerably less expensive. And, it is specifically noted that unlike UV wavelength laser sources of electromagnetic radiation applied in the present invention, Excimer Laser systems require toxic gasses, (eg. F₂, Cl₂ etc.) for their operation. By comparison then, 266 nm Nd-YAG laser ablation systems cost significantly less than said Microlas 193 nm laser ablation systems, and are simpler, more compact, and easier to align and use.

It is further disclosed that Simon-Jackson has provided a Nd-YAG Laser ablation system which provides up to 50 mJ output, at 266 nm. Said Simon-Jackson system, however, includes a beam splitter which diverts half the beam and with limited (moderate) focusing it provides a relatively low energy density, Gaussian (non-homogenized), profile electromagnetic beam to a sample. It is noted that Gaussian beam profiles are particulalry undesirable regardless of peak energy density, as beam regions, especially the edges, displaced from the center are too low in energy density.

For insight, as alluded to, material aerosol vapors resulting from sample system ablation can be analyzed by inductively coupled plasma (ICP-OES) optical emission spectrometer and (ICP-MS) inductively coupled plasma mass spectrometer and (MIP) based systems. In both cases ablated material aerosol is swept via a carrier gas flow into the analysis system. In the (ICP-OES) optical emission case an inductively coupled argon plasma is typically formed for causing high temperature step-wise atomization and/or ionization of ablated material aerosol injected thereinto. This is followed by collisional excitation and optical emission analysis of emitted electromagnetic radiation. In the case where an (ICP-MS) inductively coupled plasma mass spectrometer system is used, momentum separator and skimmer cone extraction of plasma-produced ions deriving from the ablated material aerosol are swept into a low pressure environment of a mass spectrometer wherein their trajectory pathway, or time of flight is affected by applied electric and/or magnetic fields. The mass of an ion can be determined by monitoring how long it takes for an ion to pass to the detector, (time-of-flight), or by noting which detector element of a multi-detector-element detector system therein detects it, (magnetic sector), or at what quadrupole frequency the ion extracts. In addition to deficiencies in beam homogeneity energy density, and spot size diameter over which high energy density can be maintained, prior art systems and use have further exacerbated element fractionation and (ICP-OES) and (ICP-MS) calibration errors by selection of operational parameters such as an excessive number of pulses in a fixed spot location, thereby causing “drilling” too deeply into the sample, such that ablation crater diameter/depth ratios are often far less than 1.0. It is noted that when a mix of ablation vapors and particles (of varying size), are present variable element dependent transport inefficiencies arise which lead to further element fractionation and (ICP-OES) and (ICP-MS) calibration error. For example, for a narrow, deep crater, vapors and small particles will be swept out more efficiently (by carrier gas) than will be larger particles. As elements distribute (fractionate) differently among vapor and particulate size, (because of differential condensation recrystalization rates which result from differences in elemental boiling and melting points), immediately following the ablation event, the variable transport efficiency of vapor and particles of different size, weight and density from the ablation crater gives rise to (ICP-OES) or (ICP-MS) or (MIP) based system calibration error. That is, the problem of element fractionation which results from inadequate and inhomogenous energy density is exacerbated by insufficient, (ie. low), ablation crater diameter/depth ratios. It is specifically noted that prior art techniques which attempt to enhance analytical sensitivity by drilling deeply into a sample system to provide more ablated material, enhance sensitivity at the expense of increased element fractionation, calibration error and overall analytical inaccuracy.

A Search of Patents has provided:

U.S. Pat. No. 6,002,478 to Zhu is disclosed as it describes laser ablation of powder and liquid samples without accompanying splashing etc., by first causing said powder or liquid to be adsorbed or absorbed by a porous material.

U.S. Pat. No. 5,995,265 to Black et al. describes a method and apparatus for treating a surface with a scanning laser beam, including a beam homogenizing means comprising a convex mirror which obscures the center of a radially Gaussian energy profile, thereby providing a better cross-sectional beam intensity.

U.S. Pat. No. 5,835,647 to Fischer et al. describes a device for generating a laser beam having a homogenized cross section. The system comprises a broken transmission fiber transparent to the wavelength involved to effect homogenization.

U.S. Pat. No. 5,796,521 to Kahlert et al. describes use of a plurality of acentric cylindrical lenses which are oriented perpendicular to the beam axis to effect beam homogenization.

U.S. Pat. No. 5,264,412 to Ota et al. describes a homogenizing means comprising a sequence of concave optic-convex optic-biprism shaped elements applied in a laser ablation method for depositing superconducting thin films.

U.S. Pat. No. 5,414,559 to Burghardt et al. describes a device for homogenizing a laser beam comprising elements which are convex on one side and prismatic on the other.

U.S. Pat. No. 5,959,779 to Yamazaki et al. describes a laser irradiation apparatus which includes a beam homogenization means comprising two multi-cylindrical lenses which are oriented non-parallel to one another.

U.S. Pat. No. 5,504,303 to Nagy describes a diamond polishing and finishing system combined with measurement means, which utilizes a multi-mode laser.

U.S. Pat. No. 6,023,040 to Zahavi et al. describes a scanning laser beam system for application in laser assisted polishing a material layer.

Further, references which are incorporated by reference herein, which describes (ICP-OES) and (ICP-MS) are:

Handbook of Inductively Coupled Plasma Mass Spectrometry; Jarvis and Gray, Blackie, Chapman & Hall, 1992;

Inductively couple Plasma in Analytical Atomic Spectrometry; Montaser and Golightly, VCH, 1992;

Chemical Analysis, A Series of Monographs on Analytical Chemistry and Its Applications, Elving & Winefordner, John Wiley & Sons;

Inductively Coupled Plasma Emission Spectroscopy—Part 1, Boumans, John Wiley & Sons, 1976;

Inductively Coupled Plasma Emission Spectroscopy—Part 2, Boumans, John Wiley & Sons, 1976.

Even in view of the prior art, there remains need, in the context of use with plasma based analysis systems, for a small, relatively inexpensive laser ablation system which simultaneously substantially overcomes sample absorbancy limitations and uncontrolled time and sample system material dependent fractional distillation matrix effects and accompanying accuracy and calibration error problems while simultaneously utilizing a sufficiently large spot diameter to yield high analytical sensitivity and maintaining a diameter/depth ratio sufficient to minimize element fractionation. And, in view of size, ease of alignment, transportability, cost and simplicity of use benefits associated with 213 or 266 nm Nd-YAG, and other 200-380 nm UV laser (as compared to more bulky and expensive Excimer, which often are used to produce less than 200 nm wavelength, (eg. 157 and 193 nm)), It should be appreciated that utility would be associated with meeting said need using a Nd-YAG 213 or 266 nm laser system, or other laser system which produces UV wavelengths in the range of 200-380 nm other than Excimer lasers. Further, need exists for a method of ablating materials from sample systems, such as gem stones, in a way which, regardles of the laser source utilized, leaves the sample system unchanged as detectable by observation or conventional weighing techniques, or which can be made so by means such as simple secondary jeweler's polishing. In addition, need exists for methodology and criteria for adjusting electromagnetic radiation characterizing parameters such as wavelength, degree of homogenization, fluence (energy density), pulse duration, pulse repetition rate, total number of pulses applied to a location on a sample system, and beam spot diameter of electromagnetic radiation pulses at a location at which they impinge on a sample system, for use in ablating specified sample systems as monitored by, for instance, ratios of ablated high to low boiling point elements or compounds over time, ablated region aspect ratio of diameter to depth, substantially uniform ablation over the diameter of an ablated region, and degree of beam homogenization as evidenced by radial energy distribution uniformity.

### DISCLOSURE OF THE INVENTION

Generally, the present invention system and methodology recognize and teach that, in contrast to prevalent conventional wisdom, it is not laser wavelength which is the sole or primary governing factor in controlling localized step-wise absorbance heating, melting and boiling versus optically induced direct solid-to-gas laser ablation mechanisms. The present invention teaches that sample system materials variously demonstrate wavelength dependent characteristic thresholds for laser fluency, (ie. energy density), and ablation crater width/depth aspect ratio, below which thresholds the uncontrolled localized stepwise heating mechanism, and fractionated vapor/aerosol transport prevail, and above which thresholds the direct optically induced solid-to-gas ablation mechanism and efficient (non-fractionated) vapor/aerosol transport prevail. The present invention further emphasizes that it is particularly important to be able to provide ablating energy in focused spot areas of sufficiently large diameter to ensure an adequate volume (mass) of ablated material for (ICP-OES) and (ICP-MS) and (MIP) based analysis systems to be sensitive thereto, and to ensure that the solid to gas energy density threshold is uniformly exceeded everywhere within said focused spot area.

A key insight provided by the inventors of the present invention is that while the energy density threshold value for a given material changes with wavelength, it is not entirely sufficient to say that shorter laser wavelengths, (eg. 193 nm), are “better” at yielding a “pure” optically induced direct solid-to-gas ablation mechanism, but rather that the threshold “fluence (energy density)” above which a nearly “pure” optically induced direct solid-to-gas ablation mechanism occurs is simply lower at say 193 nm, than it is for, say, 213 or 266 nm, and particularly for 1064 nm. With that in mind, it is to be understood that the present invention utilizes an 85% (and preferably 95% or better) homogenized energy content, (as opposed to Gaussian Profile), preferably Ultra-Violet UV, (ie. 200-380 nm wavelength, as opposed to 380-700 nm visible, 1064 nm NIR, or a less than 200 nm Excimer fluency, (eg. 40-700 micron diameter), spot size, (in comparison to all known prior art Ultra-Violet (UV) 200-380 nm wavelength Lasers which provide homogenized or othewise energy content beams), and is utilized in combination with (ICP-OES) optical emission and (ICP-MS) mass spectrometer and (MIP) based analysis systems. As a very relevant example, known prior art UV wavelength Nd-YAG laser ablation systems operate in the power output range of 2-20 mJ, at 266 nm or 213 nm, due to insufficient laser output and/or insufficient focusing, said Laser output energy values at said wavelengths have been found to yield energy densities below the 35 J/cm², over spot diameters in the range of 40-700 microns, where said 35 J/cm² is the threshold at which a substantially “pure” direct solid-to-gas ablation mechanism occurs, (eg. in quartz samples), thus ablation results achieved using said prior art 2-20 mJ, 266 nm or 213 nm, (or with any Gaussian Profile beam), electromagnetic radiation are particularly subject to variable optical absorbancy effects and/or to time and material dependent elemental fractionation matrix effects and calibration errors associated with residual uncontrolled localized stepwise heating mechanisms over desirable large spot diameter of 40-700 microns, and/or to inadequate (ICP-OES), (ICP-MS) or (MIP) based systems sensitivity for small spot diameters, (eg. 5 -40 microns) over which higher energy density can be achieved. The less than optimum results achieved by prior art systems and methodology are then primarily due to:

low energy and/or low energy density and/or non-uniform energy densities (eg. Gaussian Profile), being presented at the site of ablation, where only part of the beam reaches the direct optical ablation threshold, and/or

insufficient laser ablation crater width/depth aspect ratios, (eg. 0.5 or greater) are achieved, (which do not favor efficient nonfractionalized removal of vapors and condensed particles of various size by carrier gas), and/or

to insufficient ablation crater spot size, (eg. below the 40-700 micron range), for sensitive (ICP-OES) and/or (ICP-MS) and/or (MIP) based analysis.

The present invention, in breaking with convention to overcome the identified problems associated with prior art systems and methodology, generally teaches use of 200-380 nm UV wavelength laser systems, and specifically use of Nd-YAG laser ablation systems which typically employ, typically, from 2-110 mJ or greater output levels at 266 nm, (which yields, with sufficient focusing demagnification, energy densities of more than 30 J/cm² and upwards of 60 J/cm², (ie. 4.5-10 GW/cm² )), to exceed the energy density threshold of “pure” optical 266 nm direct solid-to-gas laser ablation homogeneously over a 40 micron diameter or greater focused spot size, (eg. typically 40-700 micron diameter), in a wide variety of solid sample systems (eg. diamond, quartz, calcite, CaF₂ and Mg₂ and fused silica).

Table 1 serves to show maximum spot size diameters achievable for a variety of lasers with 3 mm beam and edge-clipped 2.7 mm beam cross-sections, assuming sufficient demagnification ratios to achieve thresholds of 30 and 35 J/cm² in a spot of a sample system being ablated:

TABLE 1

| | | 3 MM BEAM | | 2.7 MM BEAM | |
|---|---|---|---|---|---|
| | | SPOT DIA. | | SPOT DIA. | |
| | | MICRONS | | MICRONS | |
| ENERGY | LASER | FOR 30 & | | FOR 30 & | |
| OUTPUT | TYPE | 35 J/cm² | | 35 J/cm² | |
| 100 MJ | QUANTEL | 594 | 550 | 540 | 500 |
| | BRILLIANT | | | | |
| | GAUSSIAN | | | | |
| 80 MJ | BIG SKY | 556 | 515 | 500 | 463 |
| | MULTIMODE | | | | |
| 40 MJ | BIG SKY | 394 | 365 | 354 | 328 |
| | MULTIMODE | | | | |
| 20 MJ | BIG SKY | 278 | 258 | 255 | 232 |
| | MULTIMODE | | | | |
| 6 MJ | BIG SKY | 152 | 141 | 137 | 127 |
| | MULTIMODE | | | | |
| 4 MJ | CONTINUUM | 124 | 115 | 111 | 103 |
| | MULTIMODE | | | | |
| 2 MJ | BIG SKY | 88 | 82 | 79 | 73 |
| | MULTIMODE | | | | |

TYPICAL SPOT SIZE DIAMETERS FOR 20 HZ PULSED, 266 NM ND-YAG 3 MM BEAM AND 2.7 MM BEAM LASERS, TO ACHIEVE BOTH 30 J/CM² AND 35 J/CM² ESSENTIALLY HOMOGENEOUS THRESHOLD ENERGY DEBSITIES, FOR VARIOUS LASER SYSTEM OUTPUT POWERS. TABLE ASSUMES THE DEMAGNIFICATION TO CONCENTRATE ENTIRE LASER BEAM INTO THE INDICATED SPOT SIZE IS PRESENT IN THE SYSTEM. (NOTE THAT OPTICAL LOSSES ARE NOT INCLUDED IN THE CALCULATIONS).

(Note, the QUANTEL BRILLIANT GAUSSIAN Laser is conservatively rated at 90 mJ at 10 Hz, and for 60 mJ at 20 Hz. Present invention experimental work utilized the Quantel 100 mJ at 20 HZ system.)

Exceeding said minimum energy density, (30-35 J/cm²), threshold serves to minimize, and even eliminate time and material dependent elemental fractionalization matrix effects and calibration errors in (ICP-OES) optical emission and (ICP-MS) mass spectrometer or (MIP) mediated elemental analysis of ablated sample system materials, where ablation crater width/depth aspect ratios of 0.5 or higher, are maintained. It is emphasized that the present invention provides the only known teaching of the use of said high-energy-density 200-380 nm wavelength, (eg. 213 nm, or preferably 266 nm Nd-YAG), homogeneous beam lasers to exceed the energy density thresholds for effecting substantially optically “pure” direct solid-to-gas laser ablation, within a large area spot size of 40-700 microns diameter, for a wide variety of solid sample system materials. And, it is to be appreciated that the present invention application of homogenized, essentially constant radial energy content electromagnetic radiation facilitates and enhances desirable effects by providing relatively large volumes of uniformly ablated sample system material at energy densities above the threshold over the entire area of a 40-700 micron diameter spot size on a sample system upon which the homogenized electromagnetic radiation impinges in use. With controlled ablation, this provides reproducible ablation craters of diameters and depths which allow efficient transport of vapors and condensed particles, and accurate, sensitive (ICP-MS), ICP-OES, and (MIP) mediated system calibration and operation, largely independent of sample matrix type and properties.

Because of its significance, it is re-emphasized that preferred present invention practice involves use of relatively low cost high energy density 200-380 nm, (Nd-YAG laser systems), which provide electromagnetic pulse(s) that present samples with substantially uniform, (ie. flat or homogeneous), energy density, (eg. 30-60 J/cm² ), over a relatively large spot diameter, (eg. 40-700 microns). That is, said electromagnetic radiation demonstrates essentially minimal radial variation in fluence (energy density) over the 40-700 micron cross-sectional area thereof which impinges onto a sample system In use. Where the uniform homogeneous electromagnetic radiation energy density level is caused to be at from 30-60 J/cm² or greater by combination of laser output energy and optical focusing parameter values, the electromagnetic radiation provides substantially “pure” direct optical ablation at every point on the sample system surface it contacts, and thus effects uniform depth ablation over said entire spot area. This can be precisely controlled to yield an ablation crater width/depth aspect ratio of greater than 0.5, (preferably greater than 1.0), as controlled by ablation duration, (eg. number of pulses in YAG systems or CW energy interval ablation in Continuous Wave systems), to effect efficient nonfractionating transport of vapors and condensed particles by the carrier gas. Also, it is emphasized that as said performance is achieved over a large diameter spot, (eg. 40-700 microns diameter), a sufficient volume (mass) of ablated material is produced to simultaneously provide excellent (ICP-MS), (ICP-OES) and (MIP) mediated system sensitivity.

In combination with a (ICP-OES) or (ICP-MS) or (MIP) mediated or other plasma based analysis system, in a fairly broad sense the present invention preferred embodiment comprises a Nd-YAG, (or other laser system), laser system which applies pulses or CW energy intervals of electromagnetic radiation to a sample system, wherein the electromagnetic radiation is characterized by a combination of wavelength, degree of homogenization, fluence (energy density), pulse duration, pulse repetition rate, total number of pulses or CW energy interval duration applied to a location on a sample system, and diameter of electromagnetic radiation pulses at a location at which they impinge on a sample system, such that the result is an essentially “pure” direct optical ablation, and/or a substantially uniform ablation over the diameter of the ablated region, and/or wherein the diameter to depth aspect ratio of an ablated region is as desired, (eg. at least 0.9), and/or wherein relatively large spot diameters yield sufficient volumes of ablated material to meet minimum (ICP-OES) emission and (ICP-MS) or (MIP) mediated system sensitivity requirements for desired analytical applications involving, for instance, refractory materials, ceramics, glasses and optical materials etc. Present invention ablation of sample system material is ideally by a “pure” direct optical solid to gas ablation mechanism, (eg. sublimation), wherein said sample system ablation is not mediated by a melting and/or boiling of the ablated material. The present invention provides, for instance, a Nd-YAG laser ablation system which outputs electromagnetic radiation pulses at a fluence (energy density) of 30-60 J/cm² or more, which electromagnetic radiation pulses preferably have a radial energy distribution which is homogeneous to 85% or better, (preferably 95% or better), which electromagnetic radiation pulses are applied to substantially uniformly ablate sample system material with spot diameters of 40-700 microns, with the end result being an ablation “pit” with an aspect ratio, (ie. pit diameter-width/pit-depth), of about (0.5) or greater, (preferably 1.0 or greater). The methodology of said preferred embodiment involves optically focusing electromagnetic radiation pulses from a Nd-YAG laser or other, (excepting Excimer), laser system which provides 200-380 nm wavelength, wherein said pulses are characterized by a combination of wavelength, degree of homogenization, fluence (energy density), pulse duration, pulse repetition rate, total number of pulses, or CW energy interval, applied to a location on a sample system, and diameter of electromagnetic radiation pulses or CW energy interval at a location at which they impinge on a sample system; such that the result is an essentially “pure” direct optical solid to gas ablation, (eg. sublimation), and/or a substantially uniform ablation over the diameter of the ablated region and/or suficient sample system ablated material volume to enable desirably high (ICP-MS), (ICP-OES) or (MIP) mediated system sensitivity. (Note, the present invention provides that results of said ablation are typically entered to an (ICP-OES), (ICP-MS) or (MIP) mediated system for analysis, as vapors or fine particulate aerosols).

In a general sense the present invention is found in the use of UV wavelength electromagnetic radiation with at least 30 J/cm² homogenized beam energy content to ablate systems.

In a more definite sense, it is disclosed that the present invention system comprises a laser ablation system for analyzing sample system material comprising in any functional order:

a laser source of 200-380 nm UV electromagnetic radiation, which is capable of providing pulse(s), (or equivalent CW energy interval), electromagnetic radiation containing at least 30 J/cm² of energy over a spot size of 40-700 microns diameter or greater; and

at least one beam homogenizing means selected from the group consisting of:

a multimode laser head and a near field aperture located with respect thereto so that electromagnetic radiation exiting said multimode laser head has an essentially constant radial energy content profile and prior to becoming other than of essentially constant radial energy density content passes through said aperture, with said aperture being imaged with demagnification onto sample system;

a non-homogeneous, (eg Gaussian), laser head and a beam-coring aperture dimensioned and positioned to extract a limited section of electromagnetic radiation exiting said non-homogeneous laser head which has an approximately constant radial energy density content profile;

at least one multifaceted “fly's eye” array optic which comprises a multiplicity of essentially evenly spatially distributed effective optical lenses or facets; and

a system comprising at least one beam splitting means and at least one Gaussian profile inverting optic and at least one beam recombining means, such that electromagnetic radiation entering thereinto is caused to interact with said at least one beam splitting means, with approximately half of said electromagnetic radiation being caused thereby to pass through said at least one Gaussian profile inverter and subsequently be re-combined with the other approximately half of electromagnetic radiation which does not pass through said at least one Gaussian profile inverter, by said at least one beam recombining means;

said laser ablation system for analyzing sample system material further being in functional combination with a selection from the group consisting of:

an (ICP-OES) optical emission system,

an (ICP-MS) mass spectrometer system,

a (MIP-OES) optical emission system, and

a (MIP-MS) mass spectrometer system.

It is emphasized that said description focuses on the application of homogenized high energy density Laser produced electromagnetic radiation over an area with a relatively large spot diameter in a material ablation system which includes an (ICP) or (MIP) etc. system for use in analysis of ablated material.

A specific embodiment of the present invention is a laser ablation system for analyzing sample system material comprising in any functional order:

a 200-380 nm UV wavelength, (eg. Nd-YAG 213 or 266 nm), source of electromagnetic radiation, which is capable of providing pulse(s) or CW electromagnetic radiation;

beam expanding means;

beam collimating means;

beam homogenizing means;

beam condenser means;

aperture means;

optional beam directing means;

beam demagnifying means;

means for supporting a sample system; and

a system selected from the group consisting of:

an (ICP-OES) optical emission system,

an (ICP-MS) mass spectrometer system,

a (MIP-OES) optical emission system, and

a (MIP-MS) mass spectrometer system.

It is specifically noted that the beam demagnifying means is typically selected to provide, at the location where the electromagnetic beam impinges on a sample, an energy density of 30-60 J/cm per pulse or more over a spot size diameter in the range 40-700 microns. Note that the larger the spot size over which a uniform high energy density can be maintained, the more sample will be ablated, and hence the greater will be the amount of ablated material presented to an analysis system with the result being that better detector sensitivity can be achieved utilizing said analysis system.

Examples of acceptable laser systems and the spot size over which they provide energy densities in excess of 30-35 J/cm², applied at 20 Hz, are given in Table 1.

The beam expander can be a one-inch plano-concave fused-silica lens.

The beam collimating means can be a two-inch plano-convex fused silica lens.

The beam homogenizing means can comprise a multifaceted “fly's eye” array based optic. For instance, a functional beam homogenizing means can comprise one or more, (typically provided in pairs), sequentially arranged arrays, each of which comprises, for instance a plurality of essentially evenly spatially distributed effective optical lenses or facets, each of which effective lenses or facets generates an image of a part of electromagnetic radiation caused to pass therethrough. And, where a fly's-eye beam homogenizing means is utilized and situated to receive collimated electromagnetic radiation pulse(s), said collimated electromagnetic radiation pulse(s) are caused to pass through said beam homogenizing means, which conceptually should be interpreted to include being converged by said condenser and focused at said aperture, from which aperture they emerge as essentially constant radial energy distribution electromagnetic radiation pulse(s). Said condenser serves to superimpose images from each fly's eye facet atop one another at the location of the aperture, thus effecting a homogeneous result. It is noted that “Fly's-Eye” arrays are effective in homogenizing any electromagnetic beam, be it of an initial Gaussian, Multimode or any other cross-sectional energy distribution.

The beam homogenizing means can, alternatively comprise a system comprising at least one beam splitting means and at least one Gaussian profile inverting optic and at least one beam recombining means, such that electromagnetic radiation entering thereinto is caused to interact with said at least one beam splitting means, with approximately half of said electromagnetic radiation being caused thereby to pass through said at least one Gaussian profile inverter and subsequently be re-combined with the other approximately half of electromagnetic radiation which does not pass through said at least one Gaussian profile inverter, by said at least one beam recombining means. A practical arrangement of such a beam homogenizing means provides that electromagnetic radiation which presents with a radial energy content Gaussian profile interacts with a beam splitting means, and approximately half thereof passes through said beam splitting means and through at least one, (preferably two), sequentially arranged Gaussian profile inverter means, (eg. at least one Axicone optic), said emerging electromagnetic radiation then passing through a beam combining means. The portion of the electromagnetic radiation which reflects from the beam splitting means retains an essentially Gaussian radial energy content profile and is caused to be guided by beam directing means to the beam combining means, which reflects approximately half thereof into a co-mingled combination with the Gaussian inverted profile electromagnetic radiation which passes therethrough. Of course, part of the electromagnetic radiation which retains an essentially Gaussian radial energy content profile passes through said beam combining means, and is guided by beam directing means back to the beam splitting means, which reflects approximately half thereof into the electromagnetic radiation which enters the Gaussian profile inverter means and approximately half thereof, via said electromagnetic radiation directing means, to the beam combining means etc. etc. As a diagram is beneficial to disclosing said practical arrangement of such a Gaussian profile retaining electromagnetic radiation “looping” beam homogenizing means, better description thereof is found in the Detailed Description Section of this Specification with reference to FIG. 4a. It is emphasized that said “looping” beam homogenizing means is substantially more efficient that a single pass beam splitter arrangement. It is noted that said Gaussian inverter/Beam splitter and recombination system is effective and useful only with electromagnetic beams which have an initial Gaussian cross-sectional energy distribution.

It is noted that some laser systems inherently provide multi-mode combination, (unstable resonator), to inherently provide, for instance, 85% to 95% homogenized near field radial energy density content profile, electromagnetic radiation, and application thereof, optionally via a near field aperture with subsequent demagnified imaging of said backlit aperture onto said sample system, can facilitate development of a present invention output substantially homogenized radial energy content profile. This provides an alternative or supplemental approach to providing homogenized electromagnetic radiation which is particularly cost-effective for smaller 2-6 mJ/pulse multimode Nd-YAG lasers focused to 88-152 micron diameter spots with a homogenized energy density thereover of 30 J/cm². (See Table 1). Said near-field aperture imaging approach is also applicable where higher power multimode laser systems are utilized, but does not apply where Gaussian beams are present.

The means for supporting a sample system is typically a sample system containing cell with means for entering a carrier gas thereto, causing it to pass therethrough and exit into a sample analysis system, such as an (ICP-OES) optical emission or (ICP-MS) mass spectrometer or (MIP) mediated system.

The condenser means, typically employed with fly's eye homogenizers suited to larger 20-110 mJ per pulse Nd-YAG lasers systems capable of producing 250-600 micron diameter spots with homogenous 30-60 J/cm energy density content, serves to superimpose multiple separate images of electromagnetic radiation from the various spatially distributed effective optical lenses or facets of the “fly's eye” based array optic; and/or from combined Gaussian and inverted Gaussian profiles which exit a present beam homogenizing means, onto the final limiting aperture means.

The beam directing means typically comprise “mirror” means which reflect electromagnetic radiation, and the beam demagnifying means is typically, for example, a 200-380 nm UV microscope objective which directs electromagnetic radiation arriving thereat to a sample system on the means for supporting a sample system at, for instance, a total of 6-20×demagnification ratio, (including the effect of the Condenser). It is noted that for a given demagnification the spot size of electromagnetic radiation arriving at a sample system may be further reduced without significant accompanying energy density change at the sample system location, by reduction of the limiting aperture diameter.

With the foregoing system structure in mind, it can be appreciated that in use, said 200-380 nm UV wavelength, (eg. Nd-YAG), laser source provides a sequence of electromagnetic radiation pulse(s) which, in radial cross-section, present with an essentially Gaussian, (or other less than homogeneous), energy distribution, said pulse(s) being typically, but not necessarily, of 2-20 nsec duration and provided at as a single shot or at a repetition rate corresponding to 1-30 Hz or higher; and said electromagnetic radiation pulse(s) are expanded by said beam expander; and

said beam collimating means collimates said expanded beam radiation pulse(s); and

said collimated electromagnetic radiation pulse(s) are caused to pass through said beam homogenizing means and emerge as essentially constant radial energy density distribution electromagnetic radiation pulse(s); and

said essentially constant radial energy density distribution electromagnetic radiation pulse(s) are caused to converge by said condenser; and

pass through said final aperture; and via said beam directing and final demagnification means be directed to impinge on a sample system placed on said means for supporting a sample system, thereby causing high density, (eg. 30-60 J/cm² or more), ablation of sample system material, within relatively large spot diameters (40-700 microns), which are typically (but not necessarily), demagnified images of said final aperture;

said ablated sample system material being caused to enter said system selected from the group consisting of:

an (ICP-OES) optical emission system,

an (ICP-MS) mass spectrometer system,

a (MIP-OES) optical emission system, and

a (MIP-MS) mass spectrometer system.

wherein said ablated material is analyzed.

Where a fly's-eye array beam homogenizing means is utilized and situated to receive collimated electromagnetic radiation pulse(s), said collimated electromagnetic radiation pulse(s) are caused to pass through said beam homogenizing means which conceptually includes being converged by said condenser and focused at said final aperture, from which they emerge as essentially constant radial energy distribution electromagnetic radiation pulse(s). Further, it is noted that said condenser serves to achieve said homogenization by superimposing partially demagnified images from each fly's eye facet atop one another in said final aperture plane.

In a modified embodiment, the present invention is a laser ablation system for analyzing sample system material comprising in any functional order:

a 200-380 nm UV wavelength, (eg. Nd-YAG 213 or 266 nm), laser source of electromagnetic radiation, which is capable of providing pulse(s) or CW electromagnetic radiation;

beam homogenizing means;

optional beam directing and focusing means;

means for supporting a sample system; and

a system selected from the group consisting of:

an (ICP-OES) optical emission system,

an (ICP-MS) mass spectrometer system,

a (MIP-OES) optical emission system, and

a (MIP-MS) mass spectrometer system.

(Note that in a practical sense, a condenser and/or demagnification focusing system, to concentrate energy content, will be required prior to the sample system).

The first specific embodiment described above typically finds application where highly focused spot size is desirable, while the modified embodiment can be more easily applied in the case where, for instance, a larger spot size is desired. Both modifications, however, will, in use, provide a homogenized high energy density, (eg. 30J/cm² or more), to a sample system. The major purpose of presenting the modified embodiment is to emphasise that the present invention system can be variously configured to meet requirements of specific applications wherein substantially “pure” optical ablation of a sample system is to be achieved.

Continuing, one specific application of the present invention that requires specific system configuration is that wherein forming a pit in a sample that is visibly noticeable in the sample system is unacceptable. Examples include for instance, where the sample system is a diamond or other precious gem stone is to be analyzed to, for instance, determine the original mine source location thereof. It should be understood that a present invention system embodiment when applied in the described application will be structured such that it does not highly focus, (or isolate), homogenized electromagnetic radiation into small spot sizes below about 100 micron diameter, and does it continue high energy density ablation for a period sufficient to effect crater depths of more than about 2 micron, but rather is structured to apply radially uniform high energy density (fluence), electromagnetic radiation over a large area, (eg. 100 micron or more diameter to provide ablated region “craters” with a diameter to depth ratio of at least (50:1) and preferably over 100:1 ). Again, where gem stones, (eg. diamonds), are the sample system, the present invention system is configured to enable ablating over, say, a 120 micron diameter area to a depth not more than about 1-2 micron total utilizing ablating pulses of laser electromagentic radiation which ablate at a rate of approximately 60 nm per pulse. Equivalent energy desnity producing CW lasers can also be applied in this application for appropriate energy intervals. It is to be appreciated that jewelers can polish out all noticeable and measurable effects of the described procedure by standard secondary polishing techniques, thereby leaving gem stone weight and appearance unaffected by present detection means, and therefore avoiding reduction in the market value thereof. An ultra-shallow, larger diameter area is thus sampled, instead of a conventional deeply drilled 6-50 micron diameter pit which can not be polished away and is therefore observable under a microscope, and perhaps even by the naked eye or jewler's ocular. This is to be appreciated in view of the fact that presently applied X-ray fluorescence and laser ablation techniques utilized in gem stone analysis adversely affect and damage gem stones in detectable ways, (eg. deep laser damage pits or X-ray induced color change), which often can not be polished away or otherwise reversed. It is noted that such a system can also be applied in analysis of gemstones, where a total demagnification is controlled, such that the fluence energy density arriving at the gemstone is controlled to effect sensitive accurate (ICP-OES), (ICP-MS) or (MIP) based system calibration and analysis, and it is noted that other than Nd-YAG laser systems, (eg. Excimer 193 nm or F2 157 nm laser systems), can be employed in the method of controlled high energy density ablation of very shallow, (eg. less than about 2 microns), depths of material from a sample system from relatively large ablation crater diameter, (eg. 120 microns), and are included within the scope of the present invention.

It should be appreciated that while any of the identified beam homogenizing means previously identified can be applied and that any laser system capable of providing 30-60 or more J/cm² over a spot size in excess of 100 microns diameter can be utilized in ablating sample system material within present invention teachings, where larger spot diameter size is desired, higher power lasers are required. Further, where higher power lasers are utilized the fly's eye and Gaussian Inventer homogenization systems, combined with suitable beam expander and collimator means suitable to avoiding component damage, are preferred. (It is noted that ablation of Diamond requires high (eg. 35 J/cm² or greater), fluence as a carbon signal is difficult to detect otherwise).

Continuing, a method of preparing and analyzing sample system material comprises the steps of:

a. providing a laser ablation system for analyzing sample system material comprising in any functional order:

a 200-380 nm UV wavelength, (eg. Nd-YAG 213 or 266 nm), source of electromagnetic radiation, which is capable of providing pulse(s) or CW electromagnetic radiation; and

at least one beam homogenizing means selected from the group consisting of:

a multimode laser head and a near field aperture located with respect thereto so that electromagnetic radiation exiting said multimode laser head has an essentially constant radial energy content profile and prior to becoming other than of essentially constant radial energy density content passes through said aperture, with said aperture being imaged with demagnification onto sample system;

a non-homogeneous, (eg. Gaussian), laser head and a beam-coring aperture dimensioned and positioned to extract a limited section of electromagnetic radiation exiting said non-homogeneous laser head which has an approximately constant radial energy density content profile;

at least one multifaceted “fly's eye” array optic which comprises a multiplicity of essentially evenly spatially distributed effective optical lenses or facets; and

a system comprising at least one beam splitting means and at least one Gaussian profile inverting optic and at least one beam recombining means, such that electromagnetic radiation entering thereinto is caused to interact with said at least one beam splitting means, with approximately half of said electromagnetic radiation being caused thereby to pass through said at least one Gaussian profile inverter and subsequently be re-combined with the other approximately half of electromagnetic radiation which does not pass through said at least one Gaussian profile inverter, by said at least one beam recombining means;

said laser ablation system for analyzing sample system, material further being in functional combination with a selection from the group consisting of:

an (ICP-OES) optical emission system,

an (ICP-MS) mass spectrometer system,

a (MIP-OES) optical emission system, and

a (MIP-MS) mass spectrometer system.

such that, in use, said Source of 200-380 nm UV wavelength electromagnetic radiation is caused to provide of electromagnetic radiation to a sample system via said at least one beam homogenizing means, from which sample system material is ablated, said ablated material being caused to enter said system selected from the group consisting of:

an (ICP-OES) optical emission system,

an (ICP-MS) mass spectrometer system,

a (MIP-OES) optical emission system, and

a (MIP-MS) mass spectrometer system.

wherein said ablated material is analyzed;

b. providing a sample system;

c. causing said 200-380 nm UV laser source of electromagnetic radiation to provide electromagnetic radiation to a sample system via said at least one beam homogenizing means such that sample system material is ablated; and

d. causing at least some of said ablated sample system material to enter said selection from the group consisting of:

an (ICP-OES) optical emission system,

an (ICP-MS) mass spectrometer system,

a (MIP-OES) optical emission system, and

a (MIP-MS) mass spectrometer system.

Of course, the step of providing the laser ablation system can further include variously providing beam expanding means; beam collimating means; multiple “fly's eye” and/or Gaussian profile inverting and/or beam coring type beam homogenizing means; beam condenser means; final aperture means; beam directing means; beam demagnifying means; and means for supporting a sample system contained within a gas flow cell. And, the Source of 200-380 nm UV wavelength electromagnetic radiation can be a multimode laser with near field aperture in combination with an aperture imaging means.

A present invention method can also be considered as a method for analyzing ablated material from a sample system and comprises applying electromagnetic radiation pulse(s) from a 200-380 nm UV wavelength laser source of electromagnetic radiation to a sample system, wherein said pulse(s) are characterized by a combination of wavelength, degree of homogenization, fluence (energy density), pulse duration, pulse repetition rate, total number of pulse(s) applied to a location on a sample system, and diameter of electromagnetic radiation pulse(s) at a spot location at which they impinge on a sample system; the steps of said method comprising:

providing laser electromagnetic radiation pulse(s) of 200-380 nm UV wavelength, which have 2-20 nsec duration as a single shot or at a repetition rate corresponding to 1-30 Hz, and

which laser electromagnetic radiation pulse(s) have a degree of homogenization of 85% or greater, and

which laser electromagnetic radiation pulse(s) have a fluence (energy density) of 30 J/cm² or greater, and

which laser electromagnetic radiation pulse(s) have a diameter, at the spot location at which they are caused to impinge on a sample system, of at least 40 microns;

causing said laser electromagnetic radiation pulse(s) of 157-380 nm UV wavelength electromagnetic radiation to impinge on a sample system such that material is ablated therefrom thereby; and

entering at least some of the material ablated from said sample system to an (ICP-OES), (ICP-MS) or (MIP) based system in which it is analyzed.

The just described method can also be practiced with continuous wave laser electromagentic radiation with an energy interval set to be the functional equivalent-of the pulse(s).

The present invention further includes a method of ablating material from a sample system such as precious gems or other valuable item for analysis, in a way which is undetectable after jeweler secondary polishing comprising:

a. providing a laser ablation system for analyzing sample system material comprising in any functional order:

a laser source which produces electromagnetic radiation of any functional, (eg. 150-380 nm), wavelength, and which is capable of providing pulse(s) or CW electromagnetic radiation; and

at least one beam homogenizing means selected from the group consisting of:

a multimode laser head and a near field aperture located with respect thereto so that electromagnetic radiation exiting said multimode laser head has an essentially constant radial energy content profile and prior to becoming other than of essentially constant radial energy density content passes through said aperture, with said aperture being imaged with demagnification onto sample system, with said aperture being imaged with demagnification onto sample system;

a non-homogeneous, (eg. Gaussian), laser head and a beam-coring aperture dimensioned and positioned to extract a limited section of electromagnetic radiation exiting said non-homogeneous laser head which has an approximately constant radial energy density content profile;

at least one multifaceted “fly's eye” array optic which comprises a multiplicity of essentially evenly spatially distributed effective optical lenses or facets; and

a system comprising at least one beam splitting means and at least one Gaussian profile inverting optic and at least one beam recombining means, such that electromagnetic radiation entering thereinto is caused to interact with said at least one beam splitting means, with approximately half of said electromagnetic radiation being caused thereby to pass through said at least one Gaussian profile inverter and subsequently be re-combined with the other approximately half of electromagnetic radiation which does not pass through said at least one Gaussian profile inverter, by said at least one beam recombining means;

of which group, it is noted, the later two selections are prefered as being better able to withstand high powered laser electromagentic radiation without sustaining damage;

said laser ablation system for analyzing sample system material further being in functional combination with a selection from the group consisting of:

an (ICP-OES) optical emission system,

an (ICP-MS) mass spectrometer system,

a (MIP-OES) optical emission system, and

a (MIP-MS) mass spectrometer system.

such that, in use, said laser source electromagnetic radiation is caused to provide of electromagnetic radiation to a sample system via said at least one beam homogenizing means, from which sample system material is ablated, said ablated material being caused to enter said system selected from the group consisting of:

an (ICP-OES) optical emission system,

an (ICP-MS) mass spectrometer system,

a (MIP-OES) optical emission system, and

a (MIP-MS) mass spectrometer system.

wherein said ablated material is analyzed;

b. providing a sample system;

c. causing said laser source of electromagnetic radiation to provide electromagnetic radiation, (150-380 nm), to a sample system via said at least one beam homogenizing means such that sample system material is uniformly ablated over an area of between 40 and 700 microns diameter, and to a depth no greater than 1-2 microns such that the diameter to depth ratio exceeds about 50:1 and preferably 100:1;

d. causing at least some of said ablated sample system material to enter said selection from the group consisting of:

an (ICP-OES) optical emission system,

an (ICP-MS) mass spectrometer system,

a (MIP-OES) optical emission system, and

a (MIP-MS) mass spectrometer system.

to the end that said ablated material is analyzed; and

e. optionally applying secondary jeweler's polishing techniques to said sample system to the end that effects of said ablation procedure are not detectable by observation and/or conventional weighing techniques.

Said method of preparing and analyzing sample system material can include providing a laser ablation system for analyzing sample system material which also comprises:

beam expander means; and

beam collimating means;

prior to said at least one beam homogenizing means; and/or

optionally beam directing means after said at least one beam homogenizing means.

And said method of preparing and analyzing sample system material can include providing a laser ablation system for analyzing sample system material comprises providing:

condenser means after said at least one beam homogenizing means; and/or

optionally a final aperture and beam demagnification means after said condenser means, and prior to said means for supporting a sample system.

It is noted that a reason for providing a beam expander can be to effect utilization of as many lenses or facets of a fly's eye array as possible, to improve beam homogenization. Another reason to provide a beam expander is to reduce the fluence (energy density) arriving at the at least one beam homogenizing means from a laser head, so that material from said at least one beam homogenizing means does not become damaged, (ablated), thereby considering a Gaussian beam profile with high fluence. However, at low input fluence energy density from a laser head, (eg. from smaller lasers in Table 1), it is possible that said beam expander can be eliminated. Further, while it is typical to provide demagnification means after said at least one beam homogenizing means and condenser, if the beam fluence (energy density) is sufficiently high without it, for application to low melting point sample materials, it can be applied directly to a sample system without being passed through said demagnification means, or demagnification power might be reduced. This might be the case where a sample system is easily ablated, (eg. some polymer samples).

In view of the foregoing, it is further noted that even when ablating a solid sample system with relatively high fluence (energy density) and a highly homogeneous laser electromagnetic radiation, less than perfect results are possible. For instance, better success in obtaining low to high boiling point element and/or compound ratio consistency over time is achieved when ablating relatively large diameter and shallow pits, than when ablating relatively small diameter and deeper pits. A possible reason for this is that debris can be dislodged by electromagnetic radiation ablation at the edge or wall of an ablated pit, and some of said debris accumulates in said ablated pit for at least some period of time. The laser energy can cause irregular results when interacting with said edge, wall or debris, and said debris exits from said edge, wall or etched pit at uncontrolled rates and unpredictable times in various states of solidity. In view of this, a method of ablating material from a sample system which minimizes edge, wall effects, (by diminishing wall/edge depth and raising diameter to depth ratios), and variation of results over time can then comprise the steps of:

a. providing a sample system;

b. placing said sample system into a system for ablating sample systems with electromagnetic radiation;

c. while monitoring sample system ablation results over time, applying electromagnetic radiation to said sample system which are characterized by a first combination of values for:

wavelength;

degree of homogenization;

fluence (energy density);

pulse duration;

pulse repetition rate;

total number of pulses applied to a location on a sample system;

pulse(s) of electromagnetic radiation;

(or equivalent CW energy interval); and

diameter of electromagnetic radiation pulses at a location at which they impinge on a sample system;

d. while varying selections from the group consisting of:

wavelength;

degree of homogenization;

fluence (energy density);

pulse duration;

pulse repetition rate;

total number of pulses applied to a location on a sample system;

pulse(s) of electromagnetic radiation;

(or equivalent CW energy interval); and

diameter of electromagnetic radiation pulses at a location at which they impinge on a sample system;

continuing to note sample system ablation results over time and identifying combinations of said selections which provide relatively more consistent ablation results. Particularly relevant ablation results which can be monitored over time are selected from the group consisting of:

ablation was by an essentially “pure” direct optical mechanism as determined by any technique;

ablation was by an essentially “pure” direct optical solid-to-gas phase transition mechanism as evidenced by ratios (ICP-OES), (ICP-MS), or (MIP) mediated system intensity of ablated high to low melting and/or boiling point elements or compounds remaining essentially constant over time;

substantially uniform ablation depth occurred over the diameter of the ablated region;

the ablation provides an ablated region in the sample system with an aspect ratio of diameter to depth of at least 0.5; and

the electromagnetic radiation pulse(s) present with at least 85% homogenization as evidenced by measured radial energy uniformity.

For a specific sample system this methodology can be practiced to the end that settings for the identified parameters are determined which provide acceptable results as determined by (ICP-OES), (ICP-MS), or similar (MIP) based system, micrograph inspection and/or energy beam profiling results.

It is to be specifically noted that said method can provide electromagnetic radiation homogenization by combinations of, in any functional order, two or more multiple beam homogenizing means selected from the group consisting of:

a multimode laser head and a near field aperture located with respect thereto so that electromagnetic radiation exiting said multimode laser head has an essentially constant radial energy content profile and prior to becoming other than of essentially constant radial energy density content passes through said aperture, with said aperture being imaged with demagnification onto sample system, with said aperture being imaged with demagnification onto sample system;

a non-homogeneous, (eg. Gaussian), laser head and a beam-coring aperture dimensioned and positioned to extract a limited section of electromagnetic radiation exiting said non-homogeneous laser head which has an approximately constant radial energy density content profile;

at least one multifaceted “fly's eye” array optic which comprises a multiplicity of essentially evenly spatially distributed effective optical lenses or facets; and

a system comprising at least one beam splitting means and at least one Gaussian profile inverting optic and at least one beam recombining means, such that electromagnetic radiation entering thereinto is caused to interact with said at least one beam splitting means, with approximately half of said electromagnetic radiation being caused thereby to pass through said at least one Gaussian profile inverter and subsequently be re-combined with the other approximately half of electromagnetic radiation which does not pass through said at least one Gaussian profile inverter, by said at least one beam recombining means.

Continuing, a present invention method of ablating material from a sample system also comprises applying electromagnetic radiation pulses from a 200-380 nm UV wavelength, (eg. 213 or 266 nm Nd-YAG laser), to a sample system, wherein said pulses are characterized by a combination of wavelength, degree of homogenization, fluence (energy density), pulse duration, pulse repetition rate, total number of pulses applied to a location on a sample system, and diameter of electromagnetic radiation pulses at a location at which they impinge on a sample system;

such that the results of ablation indicate tha the data acquired is good by meeting the requirments of at least one selection from the group consisting of:

ablation was by an essentially pure optical mechanism as determined by any method,

ablation was by an essentially purele optically induced mechanism as evidenced by (ICP-OES), (ICP-MS) or (MIP) mediated system intensity ratios of ablated high to low boiling point elements or compounds remaining essentially constant over time;

substantially uniform depth ablation occurred over the diameter of the ablated region;

the ablation provides an ablate region in the sample system with an aspect ratio of diameter to depth of at least 0.5; and

the electromagnetic radiation pulses present with 85% homogenization as evidenced by radial energy uniformity.

Said method of ablating material from a sample system can further involve providing at least some material ablated from said sample system is entered to an (ICP-OES), (ICP-MS) or similar (MIP) based system for analysis.

And, it is noted that said method can involve use of a Continuous Wave (CW) of electromagnetism in place of the recited pulses of electromagentic radiation, where the applied energy interval parameters are such to provide essentially purely optically induced ablation.

Said method of ablating material from a sample system can involve applying electromagnetic radiation pulses from a Nd-YAG laser to a sample system involves applying electromagnetic radiation pulses which are characterized by a fluence (energy density) of 30 J/cm² or more per pulse and/or setting the degree of homogenization to 85% or greater.

It is also to be specifically understood that the present invention has as a goal the uniform ablation of material from sample systems over a cross sectional area. This includes ablating at a constant depth, both centrally and at the edge of a pit, as a result of the electromagnetic radiation having an essentially radially constant energy distribution. Where radial homogenization of the electromagnetic radiation is not sufficient, it is noted that ablation stratification occurs where a pit is etched into a sample system. That is, the central portion of a pit is etched more deeply than is the edge, and if different strata in a sample system have different composition, this effect prevents accurate characterization of said strata.

It should be appreciated that a present invention sample system material ablation system can be configured to condense and focus substantially radially homogenized energy content electromagnetic radiation pulse(s) into a small spot size on the order of 40 microns in diameter, or to provide a spot size on the order of 120 micron diameter, (ie. within a range of about 100-700 microns, which can be useful where shallow etching depths are beneficial, such as when analyzing gem stones or other valuable item). Of course to maintain an energy density of at least 30 J/cm² over a larger diameter spot area requires use of a higher power laser source of electromagnetic radiation. In any case, the goal is to provide a sufficient minimum volume of ablated material required for sensitive analysis in (ICP-MS), (ICP-OES) or (MIP) based systems.

Patentable aspects of the present invention are believed found in at least four areas, and/or functional combinations thereof, said four areas being:

1. the use of relatively high energy density (eg. at least 30 J/cm²), large spot size (eg. 40 microns or more), 200-380 nm UV wavelength, (eg. Nd-YAG laser 213 or 266 nm) pulse(s) of, for instance, 2-20 nsec duration at, for instance, a single shot or 1-30 HZ or higher repetition rate, including continuous wave (CW) laser electromagnetic energy applied at a functionally equivalent energy interval, such that the sample threshold for “pure” optical ablation is exceeded; and/or

2. the formation and use of 200-380 nm UV wavelength (eg. 213 nm or 266 nm Nd-YAG laser output), homogenized substantially radially constant energy density profile laser electromagnetic radiation of relatively high energy density (eg. at least 30 J/cm²) and large spot size, (eg. 40 microns or more), to ablate sample system material, combined with analysis of at least some of the ablated material by (ICP-OES) and/or (ICP-MS) and/or (MIP) based system; and/or

3. the use of radially homogenized electromagnetic radiation of any functional wavelength, (eg. 157-380 nm), to uniformly ablate sample system material from a sample system such as a gem stone over a relatively very large spot size area of between 40 and 700 microns diameter, to a depth no greater than 1-2 microns to provide diameter to depth aspect ratios on the order of 50:1 or greater; coupled with analyzing at least some of said ablated material utilizing a (ICP-OES) and/or (ICP-MS) and/or (MIP) based system; and with optionally applying secondary jeweler's polishing techniques to said sample system to the end that effects of said ablation procedure are not detectable by observation, jewler's inspection and/or conventional weighing techniques; and/or

4. determining and applying combinations of electromagnetic radiation defining parameters selected from the group consisting of:

wavelength;

degree of homogenization;

fluence (energy density);

pulse duration;

pulse repetition rate;

total number of pulses applied to a

location on a sample system;

pulse(s) of electromagnetic radiation;

(or equivalent CW energy interval); and

diameter of electromagnetic radiation pulses at a location at which they impinge on a sample system;

to achieve, for instance:

relatively constant (ICP-OES), (ICP-MS) or (similar MIP) based system intensity ratios of ablated high to low melting and/or boiling point elements or compounds over time;

ablated region an aspect ratio of diameter to depth of 0.8 or greater, in sample system ablated pits to minimize pit “edge” effects; and

substantially uniform ablation depth over the diameter of the ablated region.

For emphasis, it is specifically stated that the present invention methodology which combines:

use of present invention system produced substantially radially homogenized energy content (eg. 85% or better), 200-380 nm UV wavelength laser provided electromagnetic radiation pulse(s), (eg. 213 or 266 nm Nd-YAG laser), or Continuous Wave (CW) electromagentic radition at energy densities exceeding the “pure” optically induced ablation threshold exceeding 30 J/cm2′ (eg. 35 J/cm²), over a spot of at least 40 microns diameter to ablate sample system material from a region characterized by a diameter/depth aspect ratio of at least 0.8, and preferably 0.9 or more;

with analyzing at least some material ablated thereby from a sample system using (ICP-OES), (ICP-MS) or similar (MIP) based analysis system;

is believed to be sufficiently new, novel, non-obvious and useful to carry Patentability.

In addition, it is again noted that two preferred, (ie. “fly's eye” optical array and Gaussian Profile Inverting optics), system approaches to radially homogenizing energy content in laser produced electromagnetic radiation for laser ablation in (ICP-OES), (ICP-MS) or similar (MIP) based systems are disclosed and are specifically, but not exclusive to other systems, within the scope of the present invention. Additionally, a multimode laser head and an aperture located with respect thereto so that electromagnetic radiation exiting said multimode laser head has an essentially constant radial energy content profile and prior to becoming other than of essentially constant radial energy content passes through said aperture, with said aperture being subsequently imaged (with demagnification) onto a sample system; or a non-homogeneous energy profile producing laser head, (eg. Gaussian), in functional combination with a beam-coring aperture dimensioned and positioned to extract a limited section of electromagnetic radiation exiting said non-homogeneous laser head, to provide an approximately constant radial energy density content electromagnetic beam profile; can be applied alone or in combination with fly's eye optical array and Gaussian Profile Inverting optics to provide homogenization.

It is specified that while any UV wavelength, (eg. 200-380 nm), can be utilized in practice of the present invention, while not limiting, the preferred UV wavelength to date has been 266 nm produced by a ND-YAG operating at 20 mJ output power.

Further, it is again noted that where ablation spot size exceeds approximately 100 microns diameter, laser produced electromagnetic radiation of any wavelength which can ablate material from a sample system to a depth of approximately 1-2 microns can be utilized and is within the scope of the present invention.

Finally, it is noted that the present invention is primarily applicable to achieving enhanced results in the area of fixed spot ablation, as compared to the area of raster ablation wherein a laser beam is caused to moved along a sample system during an ablation procedure. Present invention teachings can, of course, be applied in scenarios in which sample systems are subjected to raster ablation, and with benefit, but the enhancement in results is typically less dramatic than achieved in fixed spot ablation scenarios.

The present invention will be better understood by reference to the Detailed Description Section of this Specification, with appropriate reference to the Drawings.

### SUMMARY OF THE INVENTION

It is therefore a purpose and/or objective of the present invention to teach that while the energy density threshold value for a given material change with wavelength, it is not entirely sufficient to say that shorter laser wavelengths, (eg. 193 nm), are “better” at yielding a “pure” optically induced direct solid-to-gas ablation mechanism, but rather that the threshold “fluence (energy density)” above which a nearly “pure” optically induced direct solid-to-gas ablation mechanism occurs is simply lower at say 193 nm, than it is for, say, 213 or 266 nm, and particularly for 1064 nm.

It is another purpose and/or objective of the present invention to disclose the use of relatively high energy density, (eg. 30 J/cm² or greater over spot sizes of 40 micron diameter or greater), 200-380 nm UV wavelength, (eg. 213 nm or 266 nm Nd-YAG), pulse(s), of for instance, 2-20 nsec duration at, for instance, single pulse or a 1-30 or higher Hz repetition rate in ablating sample system material analyzed in (ICP-OES), (ICP-MS), (MIP-OES) (MIP-MS) analysis system.

It is another purpose and/or objective yet of the present invention to disclose use of pulsed, (eg. 30 J/cm² or greater), or equivalent continuous wave (CW) laser systems in combination with beam homogenizing systems to provide substantially uniform relatively high energy density, over spot sizes of 40-700 micron diameter or greater to ablate sample system material to a depth of 2 microns or less, in combination with analysis of ablated material in (ICP-OES), (ICP-MS) or similar (MIP) based analysis systems. Said approach is particulary applicable to ablating material from a sample system such as precious gems and other valuable items, in a way which is undetectable or can be made so by, for instance, jeweler's secondary polishing techniques. (Note, an ablated crater depth of 6 microns or more is typically not possible to polish out to an undetectable degree).

It is another purpose and/or objective of the present invention to specifically teach formation and use of high energy density 213 nm or 266 nm Nd-YAG homogenized substantially radially constant, (eg. 30 J/cm² or greater over spot sizes of 40 micron diameter or greater), energy density profile electromagnetic radiation in ablating sample system material for analysis in (ICP-OES), (ICP-MS) or similar (MIP) based analysis systems.

It is yet another purpose and/or objective of the present invention to disclose two specific preferred beam homogenizing means embodiments for use in UV wavelength ablation systems, namely “fly's eye” optical array and Axicon Gaussian Profile inverter systems, and to further disclose other beam homogenizing means which can also be applied in practice of the present invention.

It is another purpose and/or objective yet of the present invention to describe that various sample system material ablation system configurations provide for use of condensing and focusing elements that provide substantially radially homogenized energy content electromagnetic radiation into a small spot size (eg. 40 micron diameter), and for use of condensing and focusing elements which are less effective in reducing the spot size, with the result being that a larger area spot size, (eg. 40-700 microns), of substantially homogenized radial energy content profile electromagnetic radiation is produced and applied to a sample system.

It is yet another purpose and/or objective of the present invention to describe a method of determining optimum settings for:

wavelength;

degree of homogenization;

fluence (energy density);

pulse duration;

pulse repetition rate;

total number of pulses applied to a location on a sample system;

(or equivalent CW energy interval); and

diameter of electromagnetic radiation pulses at a location at which they impinge on a sample system;

to ablate specific sample systems such that pit edge effects, as evidenced by varying ratios of high to low melting and boiling point ablated materials, are reduced.

It is another purpose and/or objective yet, of the present invention, to identify the importance of controlling the aspect ratio, (ie. diameter to depth), of an ablated pit in achieving optimum sample system analysis results.

Other purposes and/or objectives of the present invention will become apparent by a reading of the Specification and accompanying Claims.

### BRIEF DESCRIPTION OF THE DRAWINGS

FIG. 1 shows a diagram of the first specific configuration of a present invention system including Beam expanding (BE), Collimating (BC) homogenizing (H,H′), sample support (SS) means, carrier gas inlet (CGI), carrier gas outlet (CGO), and demagnification (DM) means.

FIG. 2 indicates modifications of the present invention system shown in FIG. 1. are possible in which various elements are removed or identified by dashed outlines as removable.

FIG. 3a shows a frontal view of one possible embodiment of a “fly's eye” lens array beam homogenizing means (FEH) demonstrative effective lens or facet construction from functional combination of a multiplicity of plano convex cylinder lenses oriented at ninety degrees to a second multiplicity of plano-convex cylindrical lenses.

FIG. 3b shows one preferred present invention practice is to utilize two such “fly's eye” array beam homogenizing means in sequence to form the Beam Homogenizing means (H) shown in FIGS. 1 and 2.

FIG. 4a shows another preferred present invention practice is to use at least a beam splitter (BS) and beam recombiner (BRC) with two Axicone lens Gaussian Profile inverting means (GI) and to form the Beam Homogenizing means (H) shown in FIGS. 1 and 2.

FIG. 4b shows a transmissive version of the FIG. 4a Gaussian inverters (GI).

FIG. 4c shows a reflective Gaussian inverter comprising two mirrors.

FIG. 4d shows another application of an Axicone Gaussian Inverter, in combination with a reflective and refractive lens arrangement.

FIG. 4e demonstrates a beam coring technique for isolating, from a Gaussian profile beam, a relatively homogenous energy profile electromagnetic beam to the left of the aperture,

FIG. 5 demonstrates a conventional (ICP-OES) Torch as applied in (ICP-OES) optical emission analysis systems.

FIG. 6 demonstrates a conventional Mass Spectrometer (MS) System as used in (ICP-MS) systems.

FIGS. 7 and 8 show (ICP-MS) results obtained using 40 and 60 J/cm² radially homogenized energy content electromagnetic radiation pulse(s), respectively, showing constant ablation intensity over time for all elements in an NIST glass standard, indicating absence of fractionalization effects, over a wide range of melting/boiling points.

FIG. 9 shows essentially constant, with time, ablation intensity (ICP-MS) ratios for (Pb/U) and (La/Ce), (useful in geochronology work), obtained using 30 mJ energy radially homogeneous 266 nm pulses at ablation crater diameter to depth ratios of at least 1.0.

FIG. 10 shows time invariant (Pb/U) (ICP-MS) intensity ratio reproducibility of results obtained using energy radially homogeneous 266 nm pulses, for both 30 and 70 mJ energy levels, at ablated crater diameter to depth ratios of at least 1.0.

### DETAILED DESCRIPTION

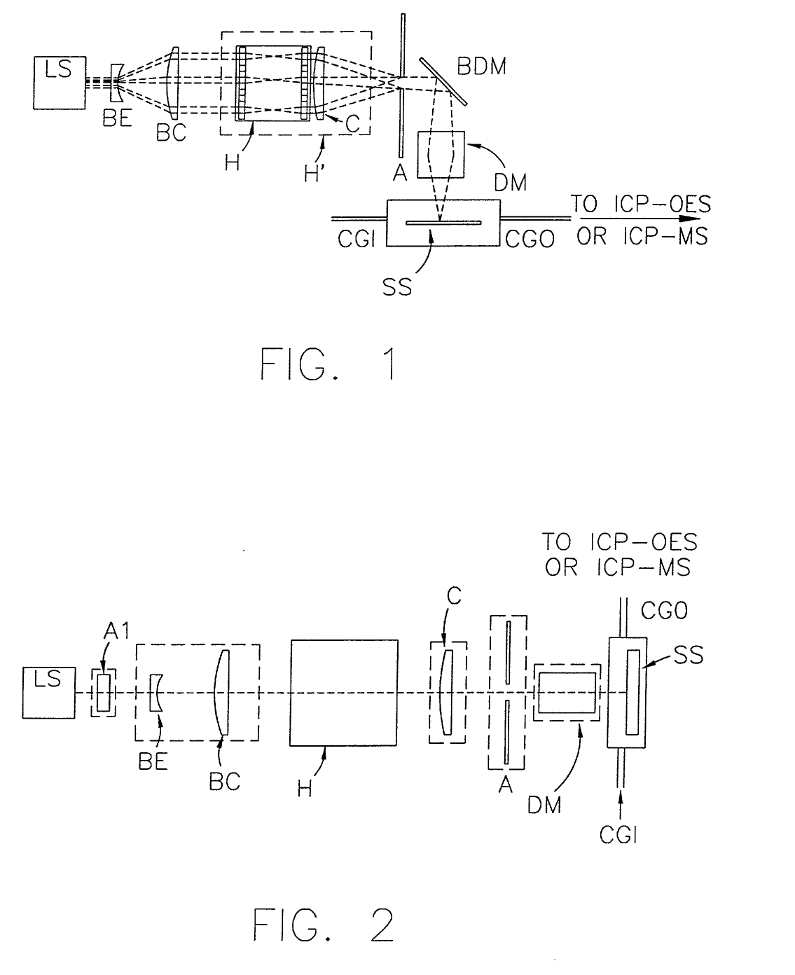

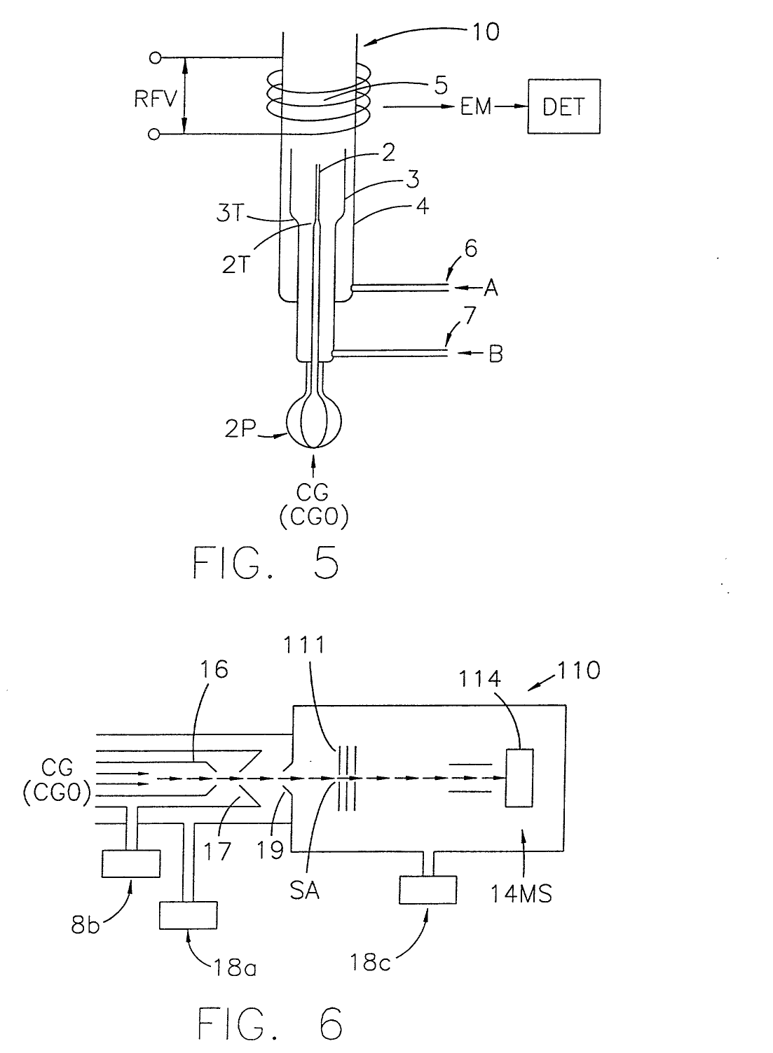

Turning now to FIG. 1, there is shown a diagram of the first and primary specific embodiment of the present invention sample system material ablation system. An exemplary and not limiting Nd-YAG source (LS) of 266 nm, (note, could use 213 nm Nd-YAG, or other UV wavelength such as 200-380 nm from another UV wavelength producing pulsed or continuous wave laser system), is shown followed sequentially by Beam Expanding means (BE), a Beam Collimating means (BC) for collimating electromagnetic radiation passed therethrough, a Beam Homogenizing means (H), (indicated as sequential dual Fly's eye array), a Condenser means (C), an Aperture means (A), a Beam Directing means (BDM), a Beam Demagnifying means (DM), (eg. UV Lens or Microscope Objective), and a Sample System (SS) in a Means for Supporting a Sample System (CELL). Said (Cell) is shown with Carrier-Gas In (CGI) and Carrier-Gas Out (CGO) Ports through which, in use, ablated sample system material carrying gas is flowed, and which carrier gas provides said ablated sample system material to an (ICP-OES) optical emission or (ICP-MS) analysis system, (see FIGS. 5 & 6 for (CGO) entry in to (ICP-OES) optical emission or (ICP-MS) analysis system). In use 200-380 nm UV wavelength, (eg. Nd-YAG 213 nm or 266 nm), electromagnetic radiation from the source (LS) thereof is expanded by Beam Expanding means (BE), and Collimated by Collimating means (BC). Homogenizing means (H) effects a substantially constant radial energy content profile over the cross-section of the electromagnetic radiation, and Condenser (C) and Beam Demagnification means serve to effect, for instance, a 6-20×original beam demagnification ratio at the spot where said electromagnetic radiation meets the sample system (SS), said demagnified beam presenting, (at SS), a demagnified image of the backlit Aperture (A). Note that the spot size of said electromagnetic radiation at the sample system can be adjusted, (eg. between 1-700 microns), by adjustment of the Aperture (A) diameter, without affecting energy density applied in a spot at the sample system (SS) surface. It is briefly noted that the shown directions of curvature of (BE), (BC) and (C) in FIGS. 1 and 2 could generally be reversed and remain within the scope of the present invention, said directions of curvature being selected on the basis of, for instance, aberation minimization considerations.

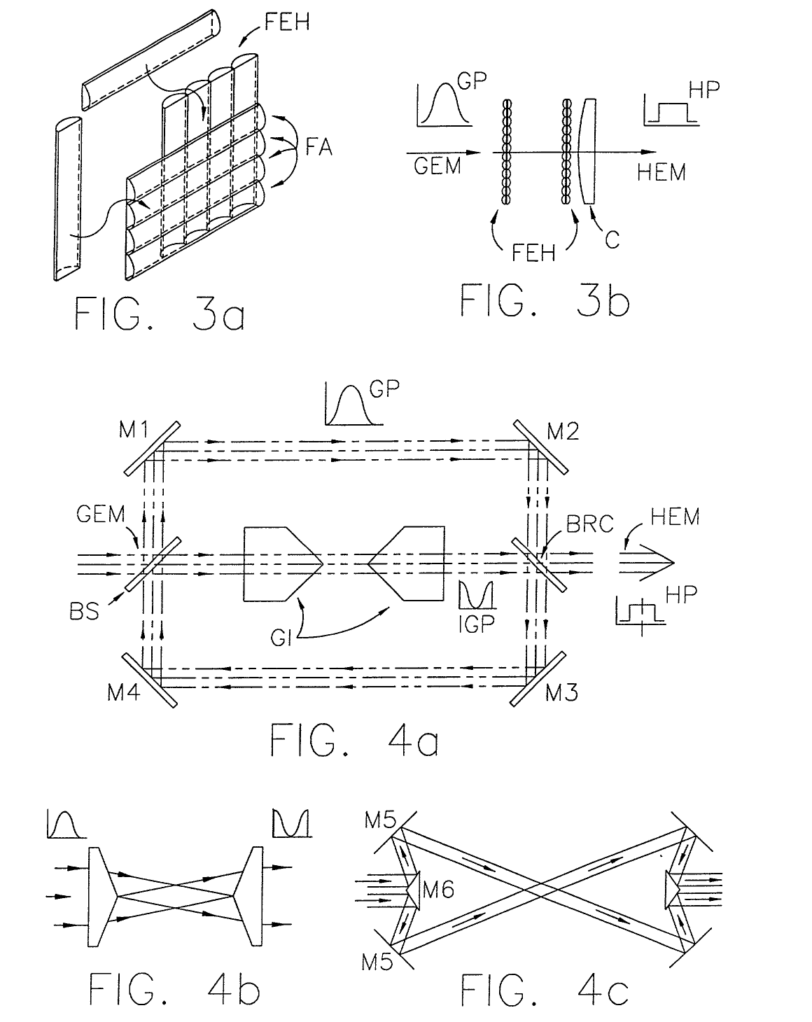

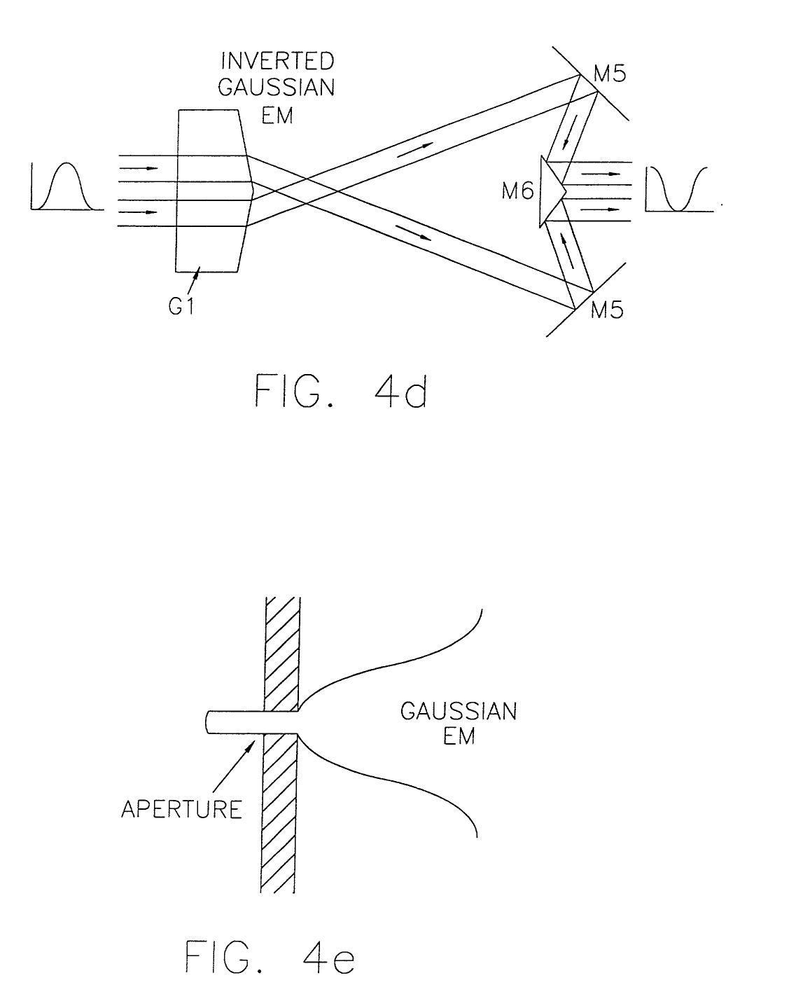

As further indicated in FIG. 3b, it is to be noted that the Beam Homogenizing means (H) is shown combined with the Condenser (C) within a dashed line box (H′ of FIG. 1). This is especially relevant in the case where a fly's eye array beam homogenizing means is utilized as the fly's eye array beam homogenizing means, (eg. (FEH) of FIG. 3a), requires combination with a Condenser (C) to provide homogenized electromagnetic radiation at the Aperture (A), (see FIG. 1). A Condenser (C) is also typically utilized with Axicone Beam Homogenizing means (H), (see FIG. 4a), as a means to focus the electromagnetic radiation onto Aperture (A).

FIG. 2 shows a modified present invention system in which the Beam Directing means (BDM) is optionally removed, (ie. (BDM) could be present) and in which the Condenser means (C) and Beam Demagnifying means (DM) are -shown as in a dashed line box, as are the Beam Expander (BE), and Beam Collimator (BC). Note that the Beam Demagnifying means (DM) could be positioned before the Aperture (A), if it is present if functional utility could be obtained from that arrangement. The dashed boxes are presented to indicate that the components contained therewithin might be individually variously removed and provide a system remaining within the scope of the present invention. Note that an Aperture means (A) is preferred as present, but is shown in a dashed line box, as it could also be eliminated in some non-preferred embodiments. Also note that Aperture (A1) may be prevent in embodiments where, for instance, a multimode laser head is present, it will typically not be present in preferred embodiments. That is, FIG. 2 indicates that in its most basic sense, the present invention comprises a source of electromagnetic radiation (LS), a beam homogenizing means (H), demagnification means (DM), and a means for supporting a sample system (SS) which is typically contained in a gas cell with provision for entering (CGI) and exiting (CGO) carrier gas, said carrier gas being used to transport ablated material to an (ICP-OES) or (ICP-MS) analysis system, which is a part of the present invention system. It is further to be understood that the beam Homogenizing means (H), while shown as a separate non-optional unit, can be repositioned as integrated within the source of electromagnetic radiation (LS), as in the case wherein the source of electromagnetic radiation (LS) is a multimode, (unstable resonator), Nd-YAG with a 90% homogeneous output used in combination with a near-field Aperture (A1), typically in combination with Condenser (C) and Demagnifier (DM). (Note that Condensor (C) is optional in systems which utilize multimode (unstable resonator) Laser Sources). Said beam homogenizer means (H) is not shown as an “optional” element, because the present invention requires electromagnetic radiation be homogenized, but it is to be understood that the beam homogenizer means (H) can be positioned other than as is specifically shown, (eg. fully or partially as an integral part of the source of electromagnetic radiation (LS)). It is noted that even in systems which utilize a Multimode Laser Source (LS) a Fly's eye Beam Homogenizer can be added to improve the degree of homogenization. FIG. 2 is also to be interpreted to indicate that the source of electromagnetic radiation (LS) and beam homogenizing means (H) can comprise elements which perform the function of a beam expander (BE) or beam collimator (BC) or condenser (C) and remain within the scope of the present invention. Note that in system which utilize a low power multimode laser source as (LS), (see Table 1), elements (BE), (BC) and (C) may not be required and (H) may be inherently incorporated within (LS) as an effective means to homogenize a beam to 88% - 92%. Note that FIG. 2 also indicates the presence of an aperture (A1) after the Nd-YAG source (LS) and prior to the beam expander (BE). This aperture (A1) might be utilized where a laser source (LS) provides a flattened radial energy content electromagnetic radiation profile at the laser head, but which profile tends to become Gaussian with distance away therefrom. Such is the case in the multi-mode Big Sky Nd-YAG Laser systems, ULTRA, CFR-20, CFR-40 and CFR-80, (where 20, 40 & 80 signifies the milli-Joule (mJ) energy output ratings and ULTRA signifies a 6 mJ system). See Table 1 in the Disclosure of the Invention Section herein for identification of other laser systems which can be applied in practice of the present invention.

The systems of FIG. 1 and FIG. 2 can be applied to develop spot sizes of 40-700 microns diameter, of essentially constant radial energy distribution electromagnetic radiation pulse(s) that ablate pits into a sample system at a uniform rate over the cross-sectional area thereof. The FIG. 2 system can be viewed as providing the capability to be variously configured to provide very large area essentially constant radial energy distribution electromagnetic radiation pulse(s) which can be applied at lower energy density and demagnification to such as polymers, (which might be easy to ablate or be “burned” by higher fluence (energy density)), or more typically may be applied at high energy desnity using larger power Lasers, with Beam Expander, Collimaters, Fly's eye Homogenizers, Condensers, and Final Aperture (A) to produce larger spots at high energy density which are controlled to produce shallow ablation depth which can be beneficially applied to precious stones to uniformly ablate, (with undetectable damage), material over relatively large surface areas, (eg. 40 -700 microns diameter), to uniform small depth, (eg. up to 2 micron), which is “erasable” by secondary gemstone polishing while still providing sufficient ablation mass to effect sensitive (ICP-OES) or (ICP-MS) analysis. However, a FIG. 1 embodiment can also be utilized in such undetectable damage gem stone ablation (ICP-MS) applications where, for instance, high energy density Excimer or Nd-YAG laser energy is Homogenized and focused to provide an electromagnetic radiation beam with a cross-section within a range of about 40-700 microns that ablates sample system material to a depth of 1-2 microns.

Again, the FIG. 2 embodiment is presented primarily to provide insight as to how the present invention can be variously configured, and to identify minimally necessary components for developing electromagnetic radiation applied in high energy density, homogeneous sample system material ablation, with ablation craters with aspect ratios of 0.9 up to 50 or 100 or more.

FIG. 3a shows a frontal view of a “fly's eye” array beam homogenizing means (FEH) and demonstrates a preferred, but not limiting construction thereof from functional combination of a first plurality of plano convex cylindrical lenses oriented ninety degrees to a second plurality of plano convex cylindrical lenses. A suitable, non-limiting, material from which to construct said “fly's eye” array beam homogenizing means (FEH) is AR-coated Fused silica, (eg. Suprasil). As indicted in FIG. 3b , which shows a side view, a preferred present invention practice is to utilize two such “fly's eye” array beam homogenizing means in sequence to form the Beam Homogenizing means (H) shown in FIGS. 1 and 2. It is noted that one array provides homogenization, but a second provides desirable preliminary beam demagnification, in combination with Condenser (C). Also shown in FIG. 3b is indication that electromagnetic radiation (GEM), with substantially radially Gaussian profile energy content (GP), enters the dual “fly's eye” array beam homogenizing means (FEH), and exists therefrom as electromagnetic radiation (HEM) with an essentially homogeneous radial energy content profile (HP). The Condenser (C) has the effect of focusing and superimposing the electromagnetic radiation exiting the various effective optical lenses or facets (FA), onto a Final Aperature (A).

While not shown, an alternative Fly's eye homogenization system can comprise a surface, typically curved in side cross-section, said surface having a plurality of discrete regions, each thereof being a functional lens or facet.

FIG. 4a shows a beam homogenizing means which operates by receiving substantially radially Gaussian profile energy content electromagnetic radiation (GEM) at a Beam Splitting means (BS), passing approximately half of said substantially radially Gaussian profile energy content electromagnetic radiation (GEM) through at least one stage of Gaussian profile inverting optic (GI), (two stages shown), while reflecting the remaining approximately half of said substantially radially Gaussian profile energy content electromagnetic radiation (GEM), via Reflecting means (M1) and (M2) to Beam Recombining means (BRC). It should be appreciated by observation that both Gaussian (GP) and Inverted Gaussian profile (IGP) energy content electromagnetic radiation arrives at said Beam Recombining means (BRC). Note that only approximately half of the Gaussian Profile (GP) energy content electromagnetic radiation arriving at the Beam Recombining means (BRC) is immediately reflected to combine with the Inverted Gaussian profile energy content electromagnetic radiation arriving at the Beam Recombining means (BRC), by said Beam Combining Means. However, the portion of the Gaussian Profile (GP) energy content electromagnetic radiation arriving at the Beam Combining means (BS) which passes therethrough is, via Reflecting means (M3) and (M4) recycled to Beam Splitting means (BS), which reflects approximately half thereof toward the Gaussian Profile Inverting means (GI), and which passes the remaining approximately half thereof toward Reflecting means (M1), etc. The end result of such recycling and combining is that the electromagnetic radiation (HEM) exiting the Beam Combining means efficiently presents with an essentially homogeneous radial energy content profile (HP), (ie. a Gaussian component superimposed, (combined with), over an inverted Gaussian component yields a homogenized (flat top) system output (HP). It is noted that the Beam Homogenizing means embodiment of FIG. 4a may provide a more cost effective approach, than the embodiment of FIGS. 3a and 3b.

FIG. 4b shows a transmissive version of the FIG. 4a Gaussian inverters (GI), including top and bottom ray traces. FIG. 4c shows a reflective Gaussian inverter that consists of two mirrors. One cone shaped (M6), and inverse cone shaped (M5). Note that the (M5) elements are a actually the interior of a single reflector. FIG. 4d shows application of an Axicone Gaussian Inverter which comprises one refractive and one reflective Gaussian inverter component having the same overall function as half of FIG. 4b combined with half of FIG. 4c . Gaussian profile electromagnetic radiation is shown entered from the left and is shown to become inverted by interaction with Refractive Axicone (GI), which inverted Gaussian profile is shown to reflect from from the inverse cone (M5) and onto the cone shaped mirror (M6) which serves to provide an parallel inverted Gaussian profile. Note that the encountered order of the refractive and reflective elements is not determinative of the homogenizing function. Also, it is disclosed that said Gaussian inverters (GI) can comprise Axicone lenses, as available from “OPTICS FOR RESEARCH”, P.O. Box 82, Caldwell, N.J. 07006.

FIG. 4e demonstrates a beam coring approach to providing a relatively homogenous energy profile electromagnetic beam which involves application of a typically far field aperture which allows only the central-most portion of an exemplary Gaussian Profile electromagnetic beam to pass therethrough. This approach, while providing a relatively homogeneous energy density, requires that a large part of the beam must be prevented from passing to a substrate, thus wastes a lot of the laser energy. This approach would be used when greater economy is desired while still providing a modicum of homogeneous high energy density.

It is specifically to be understood that a Beam Homogenizing means (H) as shown in FIGS. 1 and 2 can be comprised of one or more FIG. 3a type “fly's eye” array beam homogenizing means, and/or one or more beam homogenizing means systems as shown in FIG. 4a. That is, for instance, it is specifically within the scope of the present invention to combine one or more FIG. 3a “fly's eye” and one or more FIG. 4a type beam homogenizing means to form a greater percentage Beam Homogenizing means (H) as indicated in FIGS. 1 and 2; as well as to use only one or more of one type of, (eg. FIG. 3a or FIG. 4a), beam homogenizing means in a FIG. 1 or 2 Beam Homogenizing means (H) which provides a more economical but lesser percent Beam Homogenizing means (H). Again, the Beam Homogenizing means (H) can be moved and integrated into the source of electromagnetic radiation (LS), prior to the Aperture (A1). To summarize, the Fly's eye array provides the greatest individual degree of homogenization and is most widely applicable to use with any Laser beam input profile, but may be the most expensive selection. The Gaussian inverter also yields good homogeneity, but can only be applied to Gaussian profile beams. The Multimode Laser head, (unstable resonator), with near field aperture and subsequent imaging, with demagnification, onto samples yields lesser (but nominally still usable), homogenization, but substantially lowers optical element costs and can be practiced only with Multimode Lasers that inherently provide near field homogeneity. The beam coring approach, with far field aperture, is another relatively inexpensive approach that may be best used with Gaussian profile beams, however, it is the least desirable in terms of energy losses and homogeneity.

Even still, it can be beneficially applied in low cost embodiments of the present invention where an optimum degree of homogeniety is not required.

As the present invention systems for, and methods of forming and applying relatively high power substantially radially homogeneous energy profile 200-380 nm UV wavelength, (eg. 213 nm, or preferably 266 nm, Nd-YAG wavelength), laser produced electromagnetic radiation pulse(s) to uniformly ablate material from sample systems, are typically used with Inductively Coupled Plasma (ICP-OES) optical emission, or Inductively Coupled Plasma Mass Spectrometer (ICP-MS) systems, FIGS. 5 and 6 are included to provide general insight to the basic elements of Inductively Coupled Plasma (ICP-OES) optical emission, and Inductively Coupled Plasma Mass Spectrometer (ICP-MS) systems, respectively.

FIG. 5 shows an conventional (ICP-OES) Torch (10), presenting with a port for entering Carrier Gas (CC) such as (CGO) in FIGS. 1 and 2. (A Microwave Induced Plasma (MIP) system is also to be considered as similarly represented thereby). Also shown are ports (6) and (7) which are used to enter gas flows A and B, which gas flows A and B are used in formation and sustaining of an argon plasma coaxially within coil region 5, and aid with injecting and containing analyte in Carrier Gas (CG) into region (5) of said (ICP-OES) Torch (10). Also shown is an RF Coil around said region (5). In use, analyte, such as material ablated from a sample system in a laser ablation system as shown in FIGS. 1 and 2 is entered to region (5) of (CIP) Torch, and RF frequency excitation (RFV) applied thereto. Resulting argon plasma discharge and collisionally excited (EM) radiation which is shown entering Detector (DET) is identifying of said analyte. Use of any (ICP-OES), (or (ICP-MS)), sample analysis system with a system which provides an essentially constant radial energy distribution 200-380 nm UV wavelength (eg. Nd-YAG laser), produced electromagnetic radiation ablation pulse above the energy density, (eg. 30 J/cm² over 40 micron diameter spot size), threshold for direct solid to gas laser ablation mechanisms, and ablation crater diameter to depth ratio of at least 0.9, is within the scope of the present invention.

FIG. 6 shows the basic elements of a typical Mass Spectrometer (MS) System (110). In particular note the internal volume (14MS) of said Mass Spectrometer System (110), and analyte containing Carrier Gas (CG) entry location. Elements (16), (17) and (19) serve to momentum separate, and direct atomized/ionized analyte entry to internal volume (14 MS). Again, said Carrier Gas (CG) can be the ablated sample system material aerosol containing (CGO) as indicated in FIGS. 1 and 2. Vacuum pumps (18a), (18b) and (18c) maintain a low pressure environment inside internal volume (14MS). In use, Sample Analyte ions (SA) particles interacts with the electric field resulting from application of accelerating voltage at draw-out plate (111), and depending on the mass/charge ratio of said sample analyte particle and variously applied electric and/or magnetic fields, enters said Detector (114) at different times, or at different locations therewithin. Said Detector (114) determines the mass of an entering Sample Analyte based upon, for instance, sample analyte particle (SA) time of flight, quadrupole extraction frequency, scanning magnetic sector and/or the location of a detector element, (within a static magnetic sector), therein detecting it. Use of any type of mass spectrometer system with a system which provides an essentially constant radial energy distribution high energy density (ie. greater than 30 J/cm²), 200-380 nm UV electromagnetic radiation, either pulsed or continuous wave, to laser ablation of sample system material spot diameters of at least 40 microns, is within the scope of the present invention.

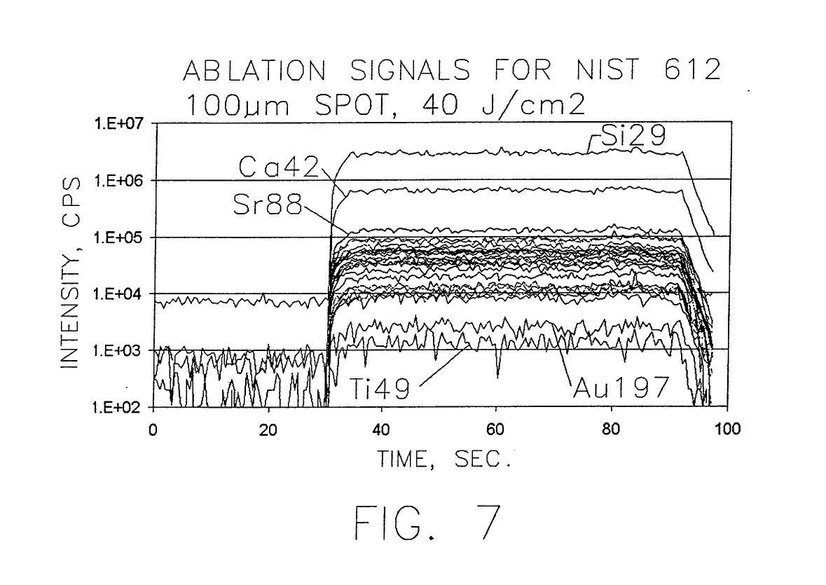

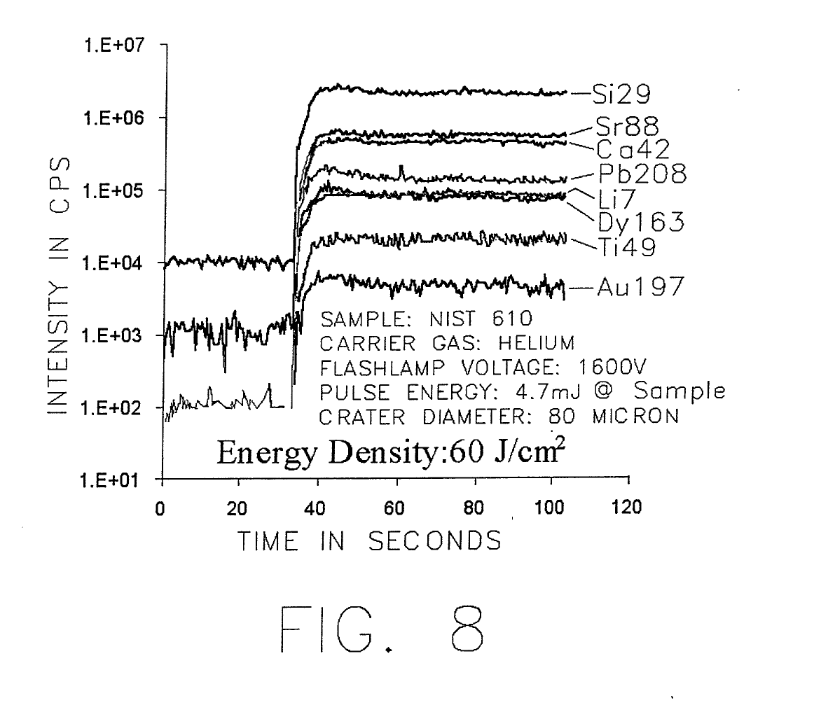

FIGS. 7 and 8 are included to demonstrate results obtained using a present invention system. FIG. 7 shows results obtained using 40 J/cm² radially homogenized energy content electromagnetic radiation pulse(s) for laser ablation/(ICP-MS) analysis of NIST 612 Glass. While not all specifically identified, it is noted that the various lines in FIG. 7 are for 7Li, 23Na, 25Mg, 29Si, 42Ca, 49Ti, 51V, 42Cr, 51V, 52Cr, 55Mn, 65Cu, 66Zn, 71Ga, 75As, 85Rb, 68St, 89Y, 107Ag, 111Cd, 115In, 118Sn, 121Sb, 133Cs, 137Ba, 139La, 140Ce, 141Pr, 153Eu, 159Tb, 163Dy, 165Ho, 169Tm, 175Lu,178Hf, 181Ta, 205Au, 208Pb, 209Bi, 232Th and 238U. The important thing to note is that all are relatively flat, (but for random system noise variations), even though the boiling points of the various elements vary greatly from one another. FIG. 8 demonstrates additional results obtained where the ablating energy density of was 60 J/cm² was applied to (ICP-MS) analysis of NIST610. Results for multiple ablations were simultaneously recorded. Said FIGS. 7 and 8 indicate relatively constant intensities and intensity ratios of Intensity signals for various elements exist over time at these energy densities and beam homogeneities. This is indicative of optically induced direct solid to gas ablation, as elements or compounds with different boiling points do not show significantly changing intensities with time, as often occurs where step-wise, kinetically controlled heating effects within a sample system being ablated control. It is note that the ability to obtain data for numerous elements which is free from the effects of boiling point differences, is very beneficial to geological analysis, and generally.

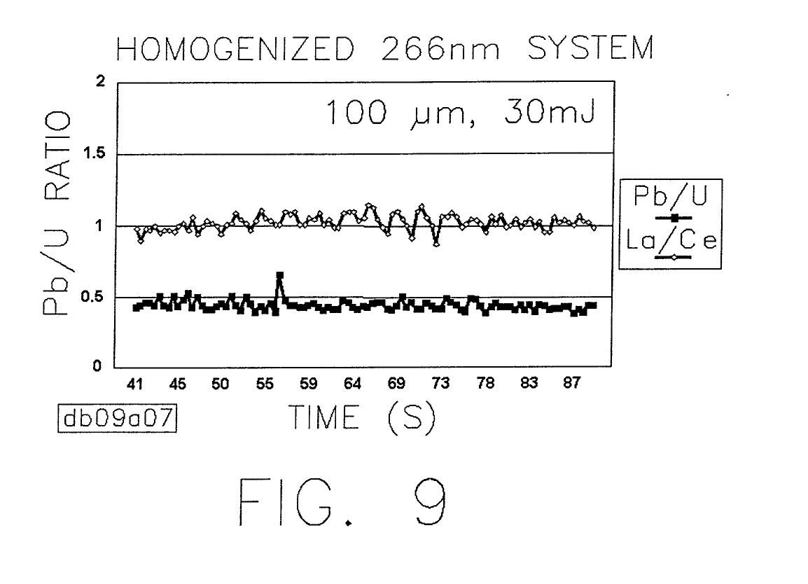

Within typical (ICP-MS) system laser ablation random noise limits, FIG. 9 shows essentially constant, with time, ablation ratios for (Pb/U) and (La/Ce) obtained using 30 mJ energy radially homogeneous 266 nm pulses condensed to a 100 micron spot. The ratio consistence with time occurs in spite of the large difference of melting/boiling points of the various elements Pb and U.

FIG. 10 shows (Pb/U) ratio reproducibility of results obtained using energy radially homogeneous 266 nm pulses, for both 30 and 70 mJ energy levels, showing the absence of elemental fractionation.

It is noted that application of (ICP-OES) and (ICP-MS) systems have been emphasised in this Section, however, application of Microwave Induced Plasma (MIP) or DC discharge etc. systems, (ie. any functional plasma based system for that matter), is to be considered within the scope of the present invention.

It is noted that the terminology “beam” has been applied to identify pulse(s) or the CW energy interval of electromagnetic radiation, but may also be interpreted to include the case where only a single pulse is utilized.

It is to be noted that the terminology “beam directing means” is to be interpreted broadly, and, while typically comprising a reflective mirror, can comprise nothing more than a direct open pathway between a beam homogenizing means and a means for supporting a sample system, and/or may include a UV microscope objective lens with, for instance, a 2-20 times demagnification.

It is also to be understood that the terminology “pulse(s) of electromagnetic radiation containing at least 30 J/cm² of energy over a spot size of 40-700 microns diameter or greater” is to be interpreted sufficiently broadly to include a Continuous Wave (CW) with a functionally equivalent amount of energy, where a Continuous Wave Laser beam system is utilized as the source. This can be considered as the condition which results where a number of sequential pulses essentially merge into an effective continuum over an ablation period.

It is also noted that the terminology “Axicon” or “Axicone” identifies an “Axial-Conical” Plano-Convex lens, lens or cone or inverse cone or equivalent.

It is also noted that beam spot size has, in this specification, been described by reciting a diameter. This is not to indicate that beam cross-sectionals are necessarily exactly circular, hence said dimension is to be broadly interpreted as generally applicable to various shaped spots.

It is also noted that the optical lenses or facets in a “fly's eye” array optic which comprises a multiplicity of essentially evenly spatially distributed effective optical lenses or facets, are typically, as viewed in a cross-section along a diameter thereof, curved along one side, but this is not a limiting restriction on facet shape.

It is also to be noted that the terminology “substantially “pure” optical ablation of material from a sample system”, means that the predominate fraction of ablated material sublimates directly from a solid state to a gas without going through any significant analysis result affecting sample system material melting and/or boiling, and residual material melting and/or boiling is restricted to a negligible or minority fration of ablated material. This occurs In most materials when the energy density of the electromagnetic radiation at the point of application to a sample system is approximately 30-35 J/cm² or greater.

It is also noted that the terminology “degree of homogenization” refers to uniformity of energy density over the area of a spot of laser electromagnetic radiation at the location where it impinges on a sample system which is to be ablated. That is, for instance, a ratio of energy density at the outer edge of a spot of laser electromagnetic radiation as compared to that at the center thereof at the location where it impinges on a sample system might be 0.85, (ie. 85% homogeneous), or ideally better, (eg. 0.9-1.0). Ideally the energy density does not vary at all over such a spot and is thus 100% homogeneous.

It is also specifically to be understood that while Nd-YAG laser sources of 213 and 266 nm UV wavelength electromagnetic radiation have been used in this Specification as comprising a preferred embodiment, application of any UV wavelength (eg. 200 -380 nm), electromagnetic radiation is within the scope of the present invention. Other UV wavelength laser source candidates include, for instance, tunable Continuous Wave (CW) Dye lasers, other CW lasers, and systems which comprise other than YAG containing Nd based lasers, (eg. Nd-YLF), and in some applications 193 nm Excimer or 157 nm F2 lasers. Where not otherwise limited the Claims should be read to include any suitable source of electromagnetic radiation.

Having hereby disclosed the subject matter of the present invention, it should be obvious that many modifications, substitutions, and variations of the present invention are possible in view of the teachings. It is therefore to be understood that the invention may be practiced other than as specifically described, and should be limited in its breadth and scope only by the Claims.

We claim:

1. A laser ablation system for analyzing sample system material comprising in any functional order:
a 200-380 nm UV wavelength laser source which is capable of providing pulse(s) or CW electromagnetic radiation (LS);
beam expanding means (BE);
beam collimating means (BC);
beam homogenizing means (H);
beam condenser means (C);
aperture means (A);
optionally beam directing means (BDM);
beam demagnifying means (DH);
means for supporting a sample system; and
a plasma based analysis system;
said beam homogenizing means being comprised of at least one multifaceted “fly's eye” array optic which comprises a multiplicity of essentially evenly spatially distributed effective optical lenses or facets;
such that in use said 200-380 nm UV wavelength laser source provides electromagnetic radiation which, in radial cross-section, presents with other than a constant radial energy distribution; and
said electromagnetic radiation is expanded by said beam expander; and
said beam collimating means collimates said expanded electromagnetic radiation; and
said collimated electromagnetic radiation is caused to pass through said beam homogenizing means including being converged by said condenser and focused at said aperture from which it emerges as essentially constant radial energy distribution electromagnetic radiation; and
be directed to impinge on a sample system placed on said means for supporting a sample system, said electromagnetic radiation substantially homogeneously providing at least 30 J/cm² over an area with a cross sectional diameter of at least 40 microns, thereby causing ablation of sample system material substantially by an optically induced direct solid-to-gas laser ablation mechanism;
at least some of said ablated sample system material being caused to enter said plasma based analysis system wherein it is analyzed.

2. A laser ablation system for analyzing sample system material as in claim 1, which further comprises a system comprising at least one beam splitting means and at least one Gaussian profile inverting optic and at least one beam recombining means, such that electromagnetic radiation entering thereinto is caused to interact with said at least one beam splitting means, with approximately half of said electromagnetic radiation being caused thereby to pass through said at least one Gaussian profile inverter and subsequently be re-combined with the other approximately half of electromagnetic radiation which does not pass through said at least one Gaussian profile inverter, by said at least one beam recombining means.

3. A laser ablation system for analyzing sample system material comprising in any functional order:
a 200-380 nm UV wavelength laser source which is capable of providing pulse(s) or CW electromagnetic radiation (LS);
beam expanding means (BE);
beam collimating means (BC);
beam homogenizing means (H);
beam condenser means (C);
aperture means (A);
optionally beam directing mean (BDM);
beam demagnifying means (BDM);
means for supporting a sample system; and
a plasma based analysis system;
said beam homogenizing means comprising a system comprising at least one beam splitting means and at least one Gaussian profile inverting optic and at least one beam recombining means, such that electromagnetic radiation entering thereinto is caused to interact with said at least one beam splitting means, with approximately half of said electomagnetic radiation being caused thereby to pass through said at least one Gaussian profile inverter and subsequently be re-combined with the other approximately half of electromagnetic radiation which does not pass through said at least one Gaussian profile inverter, by said at least one beam recombining means;
such that in use said UV wavelength laser source provides electromagnetic radiation which, in radial cross-section, presents with an essentially Gaussian radial energy distribution; and
said electromagnetic radiation being expanded by said beam expander; and
said beam collimating means collimates said expanded electromagnetic radiation; and
said collimated electromagnetic radiation being caused to pass through said beam homogenizing means and emerge as essentially constant radial energy distribution electromagnetic radiation; and
said essentially constant radial energy distribution electromagnetic radiation being caused to converge by said condenser; and
pass through said aperture; and
be directed to impinge on a sample system placed on said means for supporting a sample system, said electromagnetic radiation substantially homegeneously providing at least 30 J/cm² over an area with a cross sectional diameter of at least 40 microns, thereby causing ablation of sample system material substantially by an optically induced direct solid-to-gas laser ablation mechanism;
at least some of said ablated sample system material being caused to enter said plasma based analysis system wherein it is analyzed.

4. A laser ablation system for analyzing sample system material as in claim 3 which further comprises a beam homogenizing means which is comprised of at least one multifaceted “fly's eye” array optic which comprises a multiplicity of essentially evenly spatially distributed effective optical lenses or facets.

5. A laser ablation system for analyzing sample system material comprising in any functional order:
a 200 nm or greater UV wavelength laser source which is capable of providing pulse(s) or CW electromagnetic radiation (LS);
beam homogenizing means (H);
means for supporting a sample system; and
a system selected from the group consisting of:
an (ICP-OES) optical emission system,
an (ICP-MS) mass spectrometer system,
a (MIP-OES) optical emission system, and
a (MIP-MS) mass spectrometer system;
said beam homogenizing means being comprised of at least one multifaceted “fly's eye” array optic which comprises a multiplicity of essentially evenly spatially distributed effective optical lenses or facets;
such that in use said 200 nm or greater UV wavelength laser source provides electromagnetic radiation); and
said electromagnetic radiation is caused to pass through said beam homogenizing means; and
be directed to impinge on a sample system placed on said means for supporting a sample system, thereby causing ablation of sample system material substantially by an optically induced direct solid-to-gas laser ablation mechanism;
at least some of said ablated sample system material being caused to enter said system selected from the group consisting of:
an (ICP-OES) optical emission system,
an (ICP-MS) mass spectrometer system,
a (MIP-OES) optical emission system, and
a (MIP-MS) mass spectrometer system;
wherein it is analyzed.

6. A laser ablation system for analyzing sample system material as in claim 5, which further comprises a beam homogenizing means comprising a system comprising at least one beam splitting means and at least one Gaussian profile inverting optic and at least one beam recombining means, such that electromagnetic radiation entering thereinto is caused to interact with said at least one beam splitting means, with approximately half of said electromagnetic radiation being caused thereby to pass through said at least one Gaussian profile inverter and subsequently be re-combined with the other approximately half of electromagnetic radiation which does not pass through said at least one Gaussian profile inverter, by said at least one beam recombining means.

7. A laser ablation system for analyzing sample system material comprising in any functional order:
a 200 nm or greater UV wavelength laser source which is capable of providing pulse(s) or CW electromagnetic radiation (LS);
beam homogenizing means (H);
means for supporting a sample system; and
a system selected from the group consisting of:
an (ICP-OES) optical emission system,
an (ICP-MS) mass spectrometer system,
a (MIP-OES) optical emission system, and
a (MIP-MS) mass spectrometer system;
said beam homogenizing means comprising a system comprising at least one beam splitting means and at least one Gaussian profile inverting optic and at least one beam recombining means, such that electromagnetic radiation entering thereinto is caused to interact with said at least one beam splinting means, with approximately half of said electromagnetic radiation being caused thereby to pass through said at least one Gaussian profile inverter and subsequently be re-combined with the other approximately half of electromagnetic radiation which does not pass through said at least one Gaussian profile inverter, by said at least one beam recombining means;
such that in use said 200 nm or greater UV wavelength laser source provides electromagnetic radiation; and
said collimated electromagnetic radiation is caused to pass through said beam homogenizing means and emerge as essentially constant radial energy distribution electromagnetic radiation; and
be directed to impinge on a sample system placed on said means for supporting a sample system, said electromagentic radiation substantially homogensously providing at least 30 J/cm² over an area with a cross sectional diameter of at least 40 microns, thereby causing ablation of sample system material substantially by an optically induced direct solid-to-gas laser ablation mechanism;
at least some of said ablated sample system material being caused to enter said system selected from the group consisting of:
an (ICP-OES) optical emission system,
an (ICP-MS) mass spectrometer system,
a (MIP-OES) optical emission system, and
a (MIP-MS) mass spectrometer system;
wherein it is analyzed.

8. A laser ablation system for analyzing sample system material as in claim 7, which further comprises a beam homogenizing means which is comprised of at least one multifaceted “fly's eye” array optic which comprises a multiplicity of essentially evenly spatially distributed effective optical lenses or facets.

9. A laser ablation system for analyzing sample system material comprising in any functional order:
a 200 nm or greater UV wavelength laser source which is capable of providing pulse(s) or CW electromagnetic radiation (LS);
and at least one beam homogenizing means (H) selected from the group consisting of:
a multimode laser head and a near field aperture located with respect thereto so that electromagnetic radiation exiting said multimode laser head has an essentially constant radial energy content profile and prior to becoming other than of essentially constant radial energy density content passes through said aperture, with said aperture being imaged with demagnification;
a non-homogeneous laser head and a beam-coring aperture dimensioned and positioned to extract a limited section of electromagnetic radiation exiting said non-homogeneous laser head which has an approximately constant radial energy density content profile;
at least one multifaceted “fly's eye” array optic which comprises a multiplicity of essentially evenly spatially distributed effective optical lenses or facets; and
a system comprising at least one beam splitting means and at least one Gaussian profile inverting optic and at least one beam recombining means, such that electromagnetic radiation entering thereinto is caused to interact with said at least one beam splitting means, with approximately half of said electromagnetic radiation being caused thereby to pass through said at least one Gaussian profile inverter and subsequently be re-combined with the other approximately half of electromagnetic radiation which does not pass through said at least one Gaussian profile inverter, by said at least one beam recombining means;
said laser ablation system for analyzing sample system material further being in functional combination with a selection from the group consisting of:
an (ICP-OES) optical emission system,
an (ICP-MS) mass spectrometer system,
a (MIP-OES) optical emission system, and
a (MIP-MS) mass spectrometer system;
such that, in use, said 200 nm or greater UV wavelength laser source of electromagnetic radiation is caused to provide electromagnetic radiation to a sample system via said at least one beam homogenizing means, from which sample system material is ablated, said ablated material being caused to enter said system selected from the group consisting of:
an (ICP-OES) optical emission system,
an (ICP-MS) mass spectrometer system,
a (MIP-OES) optical emission system, and
a (MIP-MS) mass spectrometer system;
wherein said ablated material is analyzed.

10. A laser ablation system for analyzing sample system material as in claim 2 or 3 or 6 or 7 or 8 in which said beam homogenizing means (H) provides that electromagnetic radiation which presents with a radial energy content Gaussian profile interacts with said at least one beam splitting means, with approximately half thereof passing through said at least one beam splitting means and through at least two sequentially arranged Gaussian profile inverter means, said emerging electromagnetic radiation then being caused to pass through said at least one beam combining means, with the portion of the electromagnetic radiation which reflects from said at least one beam splitting means retaining an essentially Gaussian radial energy content profile and being caused to be guided by beam directing means to said at least one beam combining means, which at least one beam combining means reflects approximately half thereof into a co-mingled combination with the Gaussian inverted profile electromagnetic radiation which passes therethrough, said part of the electromagnetic radiation which retains an essentially Gaussian radial energy content profile which passes through said at least one beam combining means being guided by said beam directing means back to said at least one beam splitting means, which reflects approximately half thereof into the electromagnetic radiation which enters the Gaussian profile inverter means and approximately half thereof, via said electromagnetic radiation directing means, to said at least one beam combining means.

11. A laser ablation system for analyzing sample system material as in claims 1-9 in which the laser source of electromagnetic radiation (LS) is a Nd-YAG laser source providing a selection from the group consisting of:
266 nm; and
213 nm;
pulsed electromagnetic radiation, said pulse(s) of electromagentic radiation optionally being characterized by having 2-20 nsec duration provided as a single shot, or at a repetition rate corresponding to 1-30 Hz.

12. A method of preparing and analyzing sample system material comprising the steps of:
a. providing a laser ablation system for analyzing sample system material comprising in any functional order:
a 200-380 nm UV wavelength laser source which is capable of providing pulse(s) or CW electromagnetic radiation (LS);
and at least one beam homogenizing means (H);
said laser ablation system for analyzing sample system material further being in functional combination with a plasma based analysis system such that, in use, said 200-380 nm UV wavelength laser source of electromagnetic radiation is caused to provide electromagnetic radiation substantially homogeneously providing at least 30 J/cm² over an area with a cross sectional diameter of at least 40 microns to a sample system via said at least one beam homogenizing means, from which sample system material is ablated, at least some of said ablated material being caused to enter said plasma based analysis system wherein it is analyzed;
b. providing a sample system (SS);
c. causing said 200-380 nm UV wavelength laser source of electromagnetic radiation to provide electromagnetic radiation to a sample system via said at least one beam homogenizing means such that sample system material is ablated substantially by an optically induced direct solid-to-gas laser ablation mechanism; and
d. causing at least some of said ablated sample system material to enter said plasma based analysis system to the end that it is analyzed.

13. A method of preparing and analyzing sample system material comprising the steps of:
a. providing a laser ablation system for analyzing sample system material comprising in any functional order:
a 200-380 nm UV wavelength laser source which is capable of providing pulse(s) or CW electromagnetic radiation (LS);
at least one beam homogenizing means (H) selected from the group consisting of:
a multimode laser head and a near field aperture located with respect thereto so that electromagnetic radiation exiting said multimode laser head has an essentially constant radial energy content profile and prior to becoming other than of essentially constant radial energy density content passes through said aperture, with said aperture being imaged with demagnification;
a non-homogeneous laser head and a beam-coring aperture dimensioned and positioned to extract a limited section of electromagnetic radiation exiting said non-homogeneous laser head which has an approximately constant radial energy density content profile;
at least one multifaceted “fly's eye” array optic which comprises a multiplicity of essentially evenly spatially distributed effective optical lenses or facets; and
a system comprising at least one beam splitting means and at least one Gaussian profile inverting optic and at least one beam recombining means, such that electromagnetic radition entering thereinto is caused to interact with said at least one beam splitting means, with approximately half of said electromagnetic radiation being caused thereby to pass through said at least one Gaussian profile inverter and subsequently be re-combined with the other approximately half of electromagnetic radiation which does not pass through said at least one Gaussian profile inverter, by said at least one beam recombining means;
said laser ablation system for analyzing sample system material further being in functional combination with a plasma based analysis system such that, in use, said UV wavelength laser source of electromagnetic radiation is caused to provide electromagnetic radiation substantially homogeneously providing at least 30 J/cm² over an area with a cross sectional diameter of at least 40 microns to a sample system via said at least one beam homogenizing means, from which sample system material is ablated, at least some of said ablated material being caused to enter said plasma based system wherein it is analyzed;
b. providing a sample system;
c. causing said UV wavelength laser source of electromagnetic radiation to provide electromagentic radiation to substantially homogeneously provide at least 30 J/cm² over an area with a cross sectional diameter of at least 40 microns to a sample system via said at least one beam homogenizing means such that sample system material is ablated substantially by an optically induced direct solid-to-gas laser ablation mechanism; and
d. causing at least some of said sample system ablated material to enter said plasma based analysis system to the end that it is analyzed.

14. A method of preparing and analyzing sample system material as in claim 13 in which the step of providing a laser ablation system for analyzing sample system material includes selecting said beam homogenizing means which comprises:
a system comprising at least one beam splitting means and at least one Gaussian profile inverting optic and at least one beam recombining means, such that electromagnetic radiation entering thereinto is caused to interact with said at least one beam splitting means, with approximately half of said electromagnetic radiation being caused thereby to pass through said at least one Gaussian profile inverter and subsequently be re-combined with the other approximately half of electromagnetic radiation which does not pass through said at least one Gaussian profile inverter, by said at least one beam recombining means;
more specifically comprises providing a beam homogenizing system which provides that electromagnetic radiation which presents with a radial energy content Gaussian profile interacts with said at least one beam splitting means, with approximately half thereof passing through said at least one beam splitting means and through at least two sequentially arranged Gaussian profile inverter means, said emerging electromagnetic radiation then being caused to pass through said at least one beam combining means, with the portion of the electromagnetic radiation which reflects from said at least one beam splitting means retaining an essentially Gaussian radial energy content profile and being caused to be guided by beam directing means to said at least one beam combining means, which at least one beam combining means reflects approximately half thereof into a co-mingled combination with the Gaussian inverted profile electromagnetic radiation which passes therethrough, said part of the electromagnetic radiation which retains an essentially Gaussian radial energy content profile which passes through said at least one beam combining means being guided by said beam directing means back to said at least one beam splitting means, which reflects approximately half thereof into the electromagnetic radiation which enters the Gaussian profile inverter means and approximately half thereof, via said electromagnetic radiation directing means, to said at least one beam combining means.

15. A method of preparing and analyzing sample system material as in claim 12 or 13, in which the electromagnetic radiation comprises pulse(s) of 200-380 nm UV wavelength electromagnetic radiation which have 2-20 nsec duration and are provided as a single shot, or at a repetition rate corresponding to 1-30 Hz.

16. A method of preparing and analyzing sample system material as in claim 12 or 13, in which the electromagnetic radiation comprises continuous wave.

17. A method of preparing and analyzing sample system material as in claim 12, in which the step of providing a laser ablation system for analyzing sample system material comprises further providing:
beam expander means (BE); and
beam collimating means;
prior to said at least one beam homogenizing means (H); and
beam directing (BDM) means after said at least one beam homogenizing means (H) and before said beam directing means and the plasma based analysis system, said plasma based analysis system being selected from the group consisting of:
an (ICP-OES) optical emission system,
an (ICP-MS) mass spectrometer system,
a (MIP-OES) optical emission system, and
a (MIP-MS) mass spectrometer system;
after said means for supporting a sample system.

18. A method of preparing and analyzing sample system material as in claim 17, in which the step of providing a laser ablation system for analyzing sample system material comprises further providing:
condenser means (C) after said at least one beam homogenizing means and prior to said beam directing means; and
beam demagnification means (BDM) after said beam directing means and prior to said means for supporting a sample system.

19. A method of preparing and analyzing sample system material as in claim 13, in which the step of providing a laser ablation system for analyzing sample system material comprises further providing:
beam expander means (E); and
beam collimating means (C);
prior to said at least one beam homogenizing means (H); and
beam directing means (BDM) after said at least one beam homogenizing means and before said beam directing means and the plasma based analysis system, said plasma based analysis system being selected from the group consisting of:
an (ICP-OES) optical emission system,
an (ICP-MS) mass spectrometer system,
a (MIP-OES) optical emission system, and
a (MIP-MS) mass spectrometer system;
after said means for supporting a sample system.

20. A method of preparing and analyzing sample system material as in claim 19, in which the step of providing a laser ablation system for analyzing sample system material comprises further providing:
condenser means (C) after said at least one beam homogenizing means and prior to said beam directing means; and
beam demagnification means (BDM) aster said beam directing means and prior to said means for supporting a sample system.

21. A method of ablating material from a sample system such as precious gems for analysis, in a way which is undetectable comprising:
a. providing a laser ablation system for analyzing sample system material comprising in any functional order:
a laser source which is capable of providing pulse(s) or CW, electromagnetic radiation (LS);
at least one beam homogenizing means (H); and
means for supporting a sample system;
said laser ablation system for analyzing sample system material further being in functional combination with a plasma analysis systems such that, in use, said laser source electromagnetic radiation is caused to provide electromagnetic radiation to a sample system via said at least one beam homogenizing means, from which sample system material is ablated, at least some of said ablated material being caused to enter said plasma analysis system wherein it is analyzed;
b. providing a sample system (SS);
c. causing said laser source of electromagnetic radiation to provide electromagnetic radiation to a sample system via said at least one beam homogenizing means such that sample system material is substantially uniformly ablated over an area of between 50 and 700 microns diameter, and to a uniform depth of less than 2 microns, said ablation being substantially by an optically induced direct solid-to-gas laser ablation mechanism; and
d. causing at least some of said ablated sample system to enter said plasma based analysis system to the end that it is analyzed; and
e. optionally applying polishing techniques to said sample system to the end that effects of said ablation procedure are not detectable by observation and/or conventional weighing techniques.

22. A method of preparing and analyzing sample system material as in claim 21, in which the step of providing a laser ablation system for analyzing sample system material comprises further providing:
beam expander means (E); and
beam collimating means (C);
prior to said at least one beam homogenizing means (H); and
optionally beam directing means (BDM) after said at least one beam homogenizing means; and
wherein said plasma analysis system is selected from the group consisting of:
an (ICP-OES) optical emission system,
an (ICP-MS) mass spectrometer system,
a (MIP-OES) optical emission system, and
a (MIP-MS) mass spectrometer system.

23. A method of preparing and analyzing sample system material as in claim 21, in which the step of providing a laser ablation system for analyzing sample system material further comprises providing:
beam condenser means (C) after said at least one beam homogenizing means; and
optionally beam demagnification means (BDM) after said condenser means, and prior to said means for supporting a sample system; and
wherein said plasma based analysis system is selected from the group consisting of:
an (ICP-OES) optical emission system,
an (ICP-MS) mass spectrometer system,
a (MIP-OES) optical emission system, and
a (MIP-MS) mass spectrometer system.

24. A method of preparing and analyzing sample system material as in claim 21, in which the step of providing a laser ablation system for analyzing sample system material comprises providing:
at least one beam homogenizing means (H) selected from the group consisting of:
a multimode laser head and a near field aperture located with respect thereto so that electromagnetic radiation exiting said multimode laser head has an essentially constant radial energy content profile and prior to becoming other than of essentially constant radial energy density content passes through said aperture, with said aperture being imaged with demagnification;
a non-homogeneous laser head and a beam-coring aperture dimensioned and positioned to extract a limited section of electromagnetic radiation exiting said non-homogeneous laser head which has an approximately constant radial energy density content profile;
at least one multifaceted “fly's eye” array optic which comprises a multiplicity of essentially evenly spatially distributed effective optical lenses or facets; and
a system comprising at least one beam splitting means and at least one Gaussian profile inverting optic and at least one beam recombining means, such that electromagnetic radiation entering thereinto is caused to interact with said at least one beam splitting means, with approximately half of said electromagnetic radiation being caused thereby to pass through said at least one Gaussian profile inverter and subsequently be re-combined with the other approximately half of electromagnetic radiation which does not pass through said at least one Gaussian profile inverter, by said at least one beam recombining means; and
wherein said plasma based analysis system is selected from the group consisting of:
an (ICP-OES) optical emission system,
an (ICP-MS) mass spectrometer system,
a (MIP-OES) optical emission system, and
a (MIP-MS) mass spectrometer system.

25. A method of preparing and analyzing sample system material as in claim 21, in which the step of providing a laser ablation system for analyzing sample system material comprises further providing:
beam expander means (E); and
beam collimating means (C);
prior to said at least one beam homogenizing means; and
beam homogenizing means (H) selected from the group consisting of:
at least one multifaceted “fly's eye” array optic which comprises a multiplicity of essentially evenly spatially distributed effective optical lenses or facets; and
a system comprising at least one beam splitting means and at least one Gaussian profile inverting optic and at least one beam recombining means, such that electromagnetic radiation entering thereinto is caused to interact with said at least one beam splitting means, with approximately half of said electromagnetic radiation being caused thereby to pass through said at least one Gaussian profile inverter and subsequently be re-combined with the other approximately half of electromagnetic radiation which does not pass through said at least one Gaussian profile inverter, by said at least one beam recombining means;
beam condenser means after said at least one beam homogenizing means; and
optionally beam directing means; and
beam demagnification means after said condenser means, and prior to said means for supporting a sample system; and
wherein said plasma based analysis system is selected from the group consisting of:
an (ICP-OES) optical emission system,
an (ICP-MS) mass spectrometer system,
a (MIP-OES) optical emission system, and
a (MIP-MS) mass spectrometer system.

26. A method of ablating material from a sample system which -minimizes variation of results over time comprising the steps of:
a. providing a sample system (SS);
b. placing said sample system into a system for ablating sample systems with electromagnetic radiation;
c. while monitoring sample system ablation results over time, applying pulses of electromagnetic radiation to said sample system which are characterized by a first combination of values for:
wavelength;
degree of homogenization;
fluence (energy density);
pulse duration;
pulse repetition rate;
total number of pulses applied to a location on a sample system;
pulse(s) of electromagnetic radiation; and
diameter of electromagnetic radiation pulses at a location at which they impinge on a sample system;
d. while varying selections from the group consisting of:
wavelength;
degree of homogenization;
fluence (energy density);
pulse duration;
pulse repetition rate;
total number of pulses applied to a location on a sample system;
pulse(s) of electromagnetic radiation; and
diameter of electromagnetic radiation pulses at a location at which they impinge on a sample system;
continuing to note sample system ablation results over time and identifying combinations of said selections which provide desired ablation results.

27. A method of ablating material from a sample system which minimizes variation of results over time, as in claim 26, in which ablation desired results monitored are selected from the group consisting of:
ratios of ablated high to low boiling point elements or compounds over time;
ablated region aspect ratio of diameter to depth; and
substantially uniform ablation over the diameter of the ablated region.

28. A method of ablating material from a sample system comprising applying electromagnetic radiation pulse(s) from a 200-380 nm UV wavelength laser source of electromagnetic radiation to a sample system, wherein said pulse(s) are characterized by a combination of wavelength, degree of homogenization, fluence (energy density), pulse duration, pulse repetition rate, total number of pulse(s) applied to a location on a sample system, and diameter of electromagnetic radiation pulses at a location at which they impinge on a sample system;
such that the results of ablation indicate at least one selection from the group consisting of:
ablation was by an essentially pure optical mechanism as determined by any technique;
ablation was by an essentially pure optical direct solid-to-gas phase transition mechanism as evidenced by ratios (ICP-OES), (ICPMS), (MIP-OES) or (MIP-MS) intensity of ablated high to low melting and/or boiling point elements or compounds remaining essentially constant over time;
substantially uniform ablation depth occurred over the diameter of the ablated region;
the ablation provides an ablated region in the sample system with an aspect ratio of diameter to depth of at least 0.8; and
the electromagnetic radiation pulse(s) present with at least 85% homogenization as evidenced by measured radial energy uniformity.

29. A method of ablating material from a sample system as in claim 28, wherein at least some material ablated from said sample system is entered to an (ICP-OES), (ICP-MS), (MIP-OES) or (MIP-MS) system for analysis.

30. A method of ablating material from a sample system as in claim 28, wherein the step of applying electromagnetic radiation pulse(s) from a 200-380 nm UV wavelength laser source of electromagnetic radiation to a sample system involves applying electromagnetic radiation pulse(s) which are characterized by a fluence (energy density) of at least 30 J/cm² and a cross-sectional area of at least 40 microns.

31. A method of preparing and analyzing sample system material as in claim 28, in which the pulse(s) of 200-380 nm UV wavelength electromagnetic radiation provided have 2-20 nsec duration and are provided as a single shot, or at a repetition rate corresponding to 1-30 Hz.

32. A method of ablating material from a sample system comprising applying electromagnetic radiation pulse(s) from a 200-380 nm UV wavelength laser source of electromagnetic radiation to a sample system, wherein said pulse(s) are characterized by a combination of wavelength, degree of homogenization, fluence (energy density), pulse duration, pulse repetition rate, total number of pulse(s) applied to a location on a sample system, and diameter of electromagnetic radiation pulse(s) at a location at which they impinge on a sample system;
said method including setting the degree of homogenization to 85% or greater and electromagnetic fluence (energy density) to be 30 J/cm² or greater and the diameter of said electromagnetic radiation pulse(s) at the location at which they impinge on a sample system to be at least 40 microns.

33. A method of ablating material from a sample system as in claim 32, wherein at least some material ablated from said sample system is entered to an (ICP-OES), (ICP-MS), (MIP-OES) or (MIP-MS) system for analysis.

34. A method of preparing and analyzing sample system material as in claim 32, in which the pulse(s) of 200-380 nm UV wavelength electromagnetic radiation provided have 2-20 nsec duration and are provided as a single shot, or at a repetition rate corresponding to 1-30 Hz.

35. A method of ablating material from a sample system comprising applying electromagnetic radiation pulse(s) from a 200-380 nm UV Wavelength laser source of electromagnetic radiation to a sample system as in claim 32 in which the degree of homogenization is set by at least one beam homogenizing means (H) selected from the group consisting of:
a multimode laser head and a near field aperture located with respect thereto so that electromagnetic radiation exiting said multimode laser head has an essentially constant radial energy content profile and prior to becoming other than of essentially constant radial energy density content passes through said aperture, with said aperture being imaged with demagnification;
a non-homogeneous laser head and a beam-coring aperture dimensioned and positioned to extract a limited section of electromagnetic radiation exiting said non-homogeneous laser head which has an approximately constant radial energy density content profile;
at least one multifaceted “fly's eye” array optic which comprises a multiplicity of essentially evenly spatially distributed effective optical lenses or facets; and
a system comprising at least one beam splitting means and at least one Gaussian profile inverting optic and at least one beam recombining means, such that electromagnetic radiation entering thereinto is caused to interact with said at least one beam splitting means, with approximately half of said electromagnetic radiation being caused thereby to pass through said at least one Gaussian profile inverter and subsequently be re-combined with the other approximately half of electromagnetic radiation which does not pass through said at least one Gaussian profile inverter, by said at least one beam recombining means.

36. A method of analyzing material ablated from a sample system comprising:
applying 200-380 nm UV wavelength laser provided electromagnetic radiation pulse(s) characterized by a combination of wavelength, degree of homogenization, fluence (energy density), pulse duration, pulse repetition rate, total number of pulse(s) applied to a location on a sample system, and diameter of electromagnetic radiation pulses at a location at which they impinge on a sample system, to effect a substantially “pure” optical ablation of material from a sample system, and the electromagnetic radiation pulses present with 85% homogenization as evidenced by radial energy uniformity; and
using an (ICP-OES), (ICP-MS), (MIP-OES) or (MIP-MS) analysis system to analyze at least some ablated sample system material.

37. A method of preparing and analyzing sample system material as in claim 36, in which the pulse(s) of 200-380 nm UV wavelength electromagnetic radiation provided have 2-20 nsec duration and are provided as a single shot, or at a repetition rate corresponding to 1-30 Hz.

38. A method of analyzing material ablated from a sample system comprising:
applying 200-380 nm UV wavelength laser provided electromagnetic radiation pulse(s) characterized by a combination of wavelength, degree of homogenization, fluence (energy density), pulse duration, pulse repetition rate, total number of pulse(s) applied to a location on a sample system, and diameter of electromagnetic radiation pulse(s) at a location at which they impinge on a sample system, to effect a substantially “pure” optical ablation of material from a sample system, the criteria for determining such being that ratios of (ICP-OES), (ICP-MS), (MIP-OES) or (MIP-MS) intensity of ablated high to low melting and/or boiling point elements or compounds remaining essentially constant over time; and
using an (ICP-OES), (ICP-MS), (MIP-OES) or (MIP-MS) analysis system to analyze at least some ablated sample system material.

39. A method of analyzing material ablated from a sample system as in claim 38, wherein the substantially “pure” optical ablation is evidenced by ratios of ablated high to low boiling point elements or compounds remaining essentially constant over time.

40. A method of preparing and analyzing sample system material as in claim 38, in which the pulse(s) of 200-380 nm UV wavelength electromagnetic radiation provided have 2-20 nsec duration and are provided as a single shot, or at a repetition rate corresponding to 1-30 Hz.

41. A method of analyzing material ablated from a sample system comprising:
applying 200-380 nm UV wavelength laser provided electromagnetic radiation pulse(s) characterized by a combination of wavelength, degree of homogenization, fluence (energy density), pulse duration, pulse repetition rate, total number of pulses applied to a location on a sample system, and diameter of electromagnetic radiation pulses at a location at which they impinge on a sample system, to effect a substantially “pure” optical ablation of material from a sample system, and the ablation provides an ablate region in the sample system with an aspect ratio of diameter to depth of at least 0.8; and
using an (ICP-OES), (ICP-MS), (MIP-OES) or (MIP-MS) analysis system to analyze at least some ablated sample system material.

42. A method of preparing and analyzing sample system material as in claim 41, in which the pulse(s) of 200-380 nm UV wavelength electromagnetic radiation provided have 2-20 nsec duration and are provided as a single shot, or at a repetition rate corresponding to 1-30 Hz.

43. A method of analyzing ablated material from a sample system comprising applying electromagnetic radiation pulse(s) from a 200-380 nm UV wavelength laser source of electromagnetic radiation to a sample system, wherein said pulse(s) are characterized by a combination of wavelength, degree of homogenization, fluence (energy density), pulse duration, pulse repetition rate, total number of pulse(s) applied to a location on a sample system, and diameter of electromagnetic radiation pulse(s) at a spot location at which they impinge on a sample system;
said method comprising:
providing laser electromagnetic radiation pulse(s) of 200-380 nm UV wavelength, which have 2-20 nsec duration as a single shot or at a repetition rate corresponding to 1-30 Hz, and
which laser electromagnetic radiation pulse(s) have a degree of homogenization of 85% or greater, and
which laser electromagnetic radiation pulse(s) have a fluence (energy density) of 30 J/cm² or greater, and
which laser electromagnetic radiation pulse(s) have a diameter, at the spot location at which they are caused to impinge on a sample system, of at least 40 microns;
causing said laser electromagnetic radiation pulse(s) of 200-380 nm UV wavelength electromagnetic radiation to impinge on a sample system such that material is ablated therefrom thereby; and
entering at least some of the material ablated from said sample system to an (ICP-OES), (ICP-MS), (MIP-OES) or (MIP-MS) system in which it is analyzed.

44. A method as in claims 12-43 in which the step of providing a laser ablation system specifically involves providing a Nd-YAG laser source which provides a selection from the group consisting of:
266 nm; and
213 nm;
electromagnetic radiation.

45. A laser ablation system for applying a beam of electromagnetic radiation to a sample system comprising a beam homogenizing means (H) having at least two stages, each stage being independently selected from the group consisting of:
a multifaceted “fly's eye” array optic which comprises a multiplicity of essentially evenly spatially distributed effective optical lenses or facets; and
a system comprising at least one beam splitting means and at least one Gaussian profile inverting optic and at least one beam recombining means, such that electromagnetic radiation entering thereinto is caused to interact with said at least one beam splitting means, with approximately half of said electromagnetic radiation being caused thereby to pass through said at least one Gaussian profile inverter and subsequently be re-combined with the other approximately half of electromagnetic radiation which does not pass through said at least one Gaussian profile inverter, by said at least one beam recombining means;
said laser ablation system further comprising, in functional combination therewith, a plasma based analysis system.
